(19) United States
(12) Patent Application Publication
(10) Pub. No.: US 2023/0288524 A1
(43) Pub. Date: Sep. 14, 2023

(54) MULTIPATH SIGNAL DETECTION BY A USER EQUIPMENT

(71) Applicant: QUALCOMM Incorporated, San Diego, CA (US)

(72) Inventors: Srinivas YERRAMALLI, San Diego, CA (US); Alexandros MANOLAKOS, Escondido, CA (US); Mukesh KUMAR, Hyderabad (IN); Marwen ZORGUI, San Diego, CA (US); Mohammad Tarek FAHIM, San Diego, CA (US)

(21) Appl. No.: 18/040,571

(22) PCT Filed: Aug. 30, 2021
(86) PCT No.: PCT/US2021/048246

§ 371 Date: Feb. 3, 2023

(30) Foreign Application Priority Data
Sep. 30, 2020 (IN) 202021042515

(51) Int. Cl. G01S 5/02; G01S 5/00

(52) U.S. Cl. CPC G01S 5/0244; G01S 5/0218; G01S 5/0036

(57) ABSTRACT

A user equipment (UE) may define the classes of a plurality of path delay detection algorithms that the UE may use to identify line-of-sight positioning signals and reject non-line-of-sight positioning signals. The UE may receive a capabilities request from a location server and transmit, to the location server, a capability report indicating the classes of the plurality of path delay detection algorithms supported by the UE. The UE receives a location information request from a location server, and selects a path delay detection algorithm, which is used to perform measurements of one or more positioning signals received by the UE. The UE provides an indication of the selected path delay detection algorithm along with the positioning measurements to the location server. The location server determines or verifies a location of the UE based on the path delay detection algorithm selected by the UE and the positioning measurements.

### CLAIM OF PRIORITY

This application claims priority to India Application No. 202021042515, filed Sep. 30, 2020, entitled “MULTIPATH SIGNAL DETECTION BY A USER EQUIPMENT,” which is incorporated herein by reference in its entirety.

### BACKGROUND OF THE DISCLOSURE

### 1. Field of the Disclosure

Aspects of the disclosure relate generally to wireless communications and the like.

### 2. Description of the Related Art

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G/LTE standard. Furthermore, signaling efficiencies should be enhanced and latency should be substantially reduced compared to current standards.

Entities within a wireless communications system may participate in a positioning session to determine the location of the entity. During the positioning session, the entities may transmit and/or receive positioning signals. Multipath propagation of the positioning signals may affect the results of the positioning session.

### SUMMARY

A wireless network including user equipment (UE) and a location server may support determining a position or location of the UE. In some implementations, the UE may define classes of a plurality of path delay detection algorithms that are supported in the UE. The UE may select a path delay detection algorithm and perform measurements on one or more positioning signals using the selected path delay detection algorithm. The UE may report the location information to the location server, where the location information is based on the measurements of the one or more positioning signals. The UE may select a path delay detection algorithm, which is used to perform measurements of one or more positioning signals. The UE may provide an indication of the selected path delay detection algorithm along with the positioning measurements to the location server.

In one implementation, a method performed by a user equipment (UE) for supporting a positioning session for the UE includes receiving a location information request from a location server; selecting a path delay detection algorithm from a plurality of path delay detection algorithms supported by the UE to determine a path delay of one or more positioning signals received by the UE; performing measurements of the one or more positioning signals using the selected path delay detection algorithm; and reporting location information to the location server, wherein the location information includes the information based on the measurements and the selected path delay detection algorithm.

In one implementation, a user equipment (UE) configured for supporting a positioning session may include a wireless transceiver; at least one memory; at least one processor coupled to the wireless transceiver and the at least one memory, the at least one processor configured to: receive, via the wireless transceiver, a location information request from a location server; select a path delay detection algorithm from a plurality of path delay detection algorithms supported by the UE to determine a path delay of one or more positioning signals received by the UE; perform measurements of the one or more positioning signals using the selected path delay detection algorithm; and report, via the wireless transceiver, location information to the location server, wherein the location information includes the information based on the measurements and the selected path delay detection algorithm.

In one implementation, a user equipment (UE) configured for supporting a positioning session for the UE includes means for receiving a location information request from a location server; means for selecting a path delay detection algorithm from a plurality of path delay detection algorithms supported by the UE to determine a path delay of one or more positioning signals received by the UE; means for performing measurements of the one or more positioning signals using the selected path delay detection algorithm; and means for reporting location information to the location server, wherein the location information includes information based on the measurements and the selected path delay detection algorithm.

In one implementation, a non-transitory storage medium including program code stored thereon, the program code is operable to configure at least one processor in a user equipment (UE) for supporting a positioning session, the program code comprising instructions to: receive a location information request from a location server; select a path delay detection algorithm from a plurality of path delay detection algorithms supported by the UE to determine a path delay of one or more positioning signals received by the UE; perform measurements of the one or more positioning signals using the selected path delay detection algorithm; and report location information to the location server, wherein the location information includes information based on the measurements and the selected path delay detection algorithm.

In one implementation, a method performed by a location server for supporting a positioning session for a user equipment (UE) includes sending, to the UE, a location information request; receiving a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and determining or verifying a location of the UE based on the path delay detection algorithm selected by the UE and the location information.

In one implementation, a location server configured for supporting a positioning session for a user equipment (UE) may include a communications interface; at least one memory; at least one processor coupled to the communications interface and the at least one memory, the at least one processor configured to: send to the UE, via the communications interface, a location information request; receive, via the communications interface, a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and determine or verify a location of the UE based on the path delay detection algorithm selected by the UE and the location information.

In one implementation, a location server configured for supporting a positioning session for a user equipment (UE) includes means for sending, to the UE, a location information request; means for receiving a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and means for determining or verifying a location of the UE based on the path delay detection algorithm selected by the UE and the location information.

In one implementation, a non-transitory storage medium including program code stored thereon, the program code is operable to configure at least one processor in a location server for supporting a positioning session for a user equipment (UE), the program code comprising instructions to: send to a user equipment (UE) a location information request; receive a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and determine or verify a location of the UE based on the path delay detection algorithm selected by the UE and the location information.

### BRIEF DESCRIPTION OF THE DRAWINGS

The accompanying drawings are presented to aid in the description of various aspects of the disclosure and are provided solely for illustration of the aspects and not limitation thereof.

FIG. 1 shows a diagram of an example wireless network, according to various aspects of the disclosure. 100.

FIGS. 2A and 2B illustrate example wireless network structures, according to various aspects of the disclosure.

FIG. 3 shows a block diagram of a design of base station and user equipment (UE), which may be one of the base stations and one of the UEs in FIG. 1.

FIG. 4 shows diagram of a structure of an example subframe sequence with positioning reference signal (PRS) positioning occasions, according to aspects of the disclosure.

FIG. 5 shows an example wireless network structure which may include a UE, a base station, and a location server.

FIG. 6 is a message flow diagram with various messages sent between entities in a wireless system, which may include the UE, the base station, and the location server of FIG. 5.

FIG. 7 shows a block diagram illustrating certain exemplary features of a UE that is configured to perform positioning within a wireless network.

FIG. 8 shows a schematic block diagram illustrating certain exemplary features of a base station that is configured to perform positioning for a UE within a wireless network.

FIG. 9 shows a schematic block diagram illustrating certain exemplary features of a location server that is configured to perform positioning for a UE within a wireless network.

FIG. 10 shows a flowchart for an example operation for supporting a positioning session of a UE within a wireless network.

FIG. 11 shows a flowchart for another example operation for supporting a positioning session of a UE within a wireless network.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, consumer tracking device for tracking consumer items, packages, assets or entities such as individuals or pets, wearable (e.g., smartwatch, glasses, augmented reality (AR)/virtual reality (VR) headset, etc.), vehicle (e.g., automobile, motorcycle, bicycle, etc.), Internet of Things (IoT) device, etc.), sensors, instruments, and other devices networked together in industrial applications (Industrial Internet of Things (IIoT)), used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “wireless communication device”, a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station or transmission point or transmission reception point (TRP) may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB or gNodeB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference RF signals the UE is measuring.

Various implementations relate generally to wireless positioning operations to determine the location of a UE. Multipath propagation of positioning signals may affect the reception, and therefore the accuracy, of any related measurement data. In some implementations, the UE may select a path delay detection algorithm from a plurality of path delay detection algorithms to identify line-of-sight positioning signals and reject non-line-of-sight positioning signals to improve the accuracy of the measurement data. Furthermore, the UE may select the path delay detection algorithm based on operating conditions of the UE. The UE also may define classes of supported path delay detection algorithms and transmit the defined classes to a location server. The location server may direct the UE to select a particular class of path delay detection algorithm.

Particular implementations of the subject matter described in this disclosure can be implemented to realize one or more of the following potential advantages. In some implementations, by identifying and using the line-of-sight positioning signals, the UE may provide more accurate measurement data and/or position information to the location server thereby improving a related determined position or location. The path delay detection algorithm may be selected by the UE without requiring direction from the location server, which may improve location and/or position information more quickly.

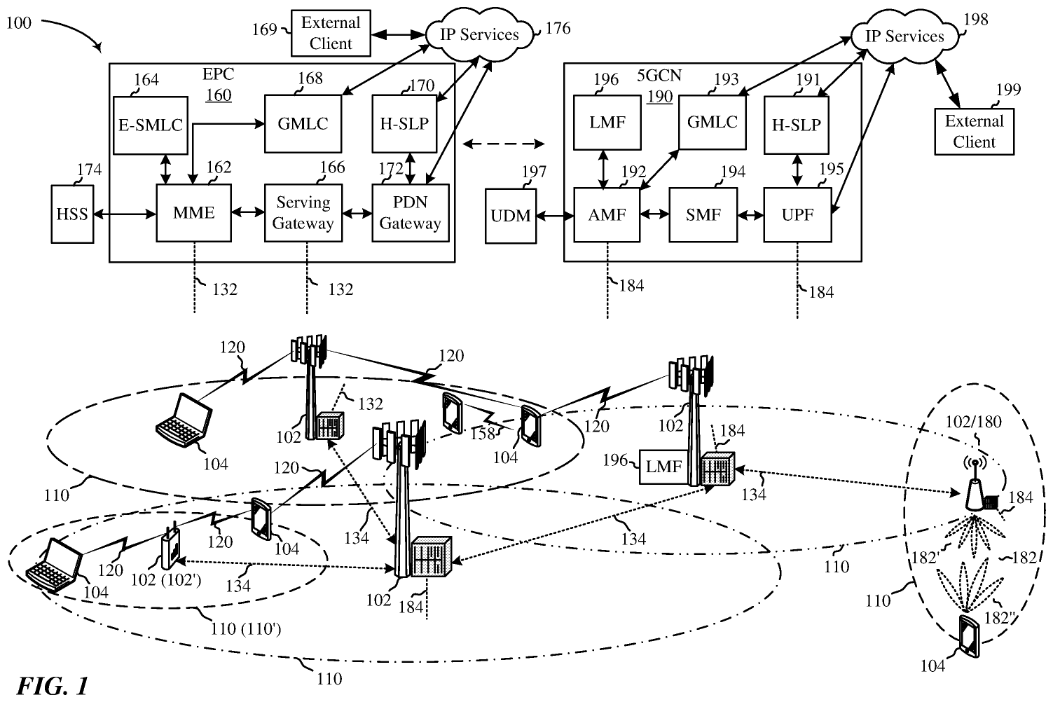

FIG. 1 shows a diagram of an example wireless network 100. The wireless communications system (also referred to as a wireless wide area network (WWAN)) includes base stations 102, UEs 104, and one or more core networks, illustrated as an Evolved Packet Core (EPC) 160 and a Fifth Generation Core (5GC) 190. While two core networks are shown the wireless communications system may use only one core network, e.g., the 5GC 190. The base stations 102 may include macrocells (high power cellular base station) or small cells (low power cellular base station). The macrocells include base stations. The small cells include femtocells, picocells, and microcells.

The base stations 102 configured for 4G LTE, referred to as eNodeB s (eNB s), (collectively referred to as Evolved Universal Mobile Telecommunications System (UMTS) Terrestrial Radio Access Network (E-UTRAN)) may interface with the EPC 160 through backhaul links 132 (such as the S1 interface). The base stations 102 configured for 5G NR, referred to as gNodeBs (gNBs), (collectively referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or 5GC 190) with each other over backhaul links 134 (such as the X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5 MHz, 10 MHz, 15 MHz, 20 MHz, 100 MHz, 400 MHz, etc.) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL).

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The small cell 102′ may operate in a licensed or an unlicensed frequency spectrum. When operating in an unlicensed frequency spectrum, the small cell 102′ may employ NR and use the same 5 GHz unlicensed frequency spectrum as used by Wi-Fi AP. The small cell 102′, employing NR in an unlicensed frequency spectrum, may boost coverage to or increase capacity of the access network.

A base station 102, whether a small cell 102′ or a large cell (such as a macro base station), may include an eNB, gNodeB (gNB), or another type of base station. Some base stations, such as gNB 180, may operate in a traditional sub 6 GHz spectrum, in millimeter wave (mmW) frequencies, or near mmW frequencies in communication with the UE 104. When the gNB 180 operates in mmW or near mmW frequencies, the gNB 180 may be referred to as a millimeter wave or mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (such as between 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 also may transmit a beamformed signal to the base station 180 in one or more transmit directions. The base station 180 may receive the beamformed signal from the UE 104 in one or more receive directions. The base station 180 and UE 104 may perform beam training to determine the best receive and transmit directions for each of the base station 180 and UE 104. The transmit and receive directions for the base station 180 may or may not be the same. The transmit and receive directions for the UE 104 may or may not be the same.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

The EPC 160, by way of example, may include a Mobility Management Entity (MME) 162, an Enhanced Serving Mobile Location Center (E-SMLC) 164, a Serving Gateway 166, a Gateway Mobile Location Center (GMLC) 168, a Home Secure User Plane Location (SUPL) Location Platform (H-SLP) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. The E-SMLC 164 may support location determination of the UEs, e.g., using the 3GPP control plane (CP) location solution. All user Internet protocol (IP) packets are transferred through the Serving Gateway 166, which itself is connected to the PDN Gateway 172. The PDN Gateway 172 provides UE IP address allocation as well as other functions. The PDN Gateway 172 is connected to the IP Services 176. The IP Services 176 may include the Internet, an intranet, an IP Multimedia Subsystem (IMS), a PS Streaming Service, and/or other IP services. The GMLC 168 may provide location access to the UE on behalf of external clients 169, e.g., that may be within or IP Services 176. The H-SLP 170 may support the SUPL User Plane (UP) location solution defined by the Open Mobile Alliance (OMA) and may support location services for UEs based on subscription information for the UEs stored in H-SLP 170.

The 5GC 190 may include an H-SLP 191, an Access and Mobility Management Function (AMF) 192, a Gateway Mobile Location Center (GMLC) 193, a Session Management Function (SMF) 194, and a User Plane Function (UPF) 195, a Location Management Function (LMF) 196. The AMF 192 may be in communication with a Unified Data Management (UDM) 197. The AMF 192 is the control node that processes the signaling between the UEs 104 and the 5GC 190 and which, for positioning functionality, may communicate with the LMF 196, which may support location determination of UEs. In some implementations, the LMF 196 may be co-located with a base station 102 in the NG-RAN and may be referred to as a Location Management Component (LMC). The GMLC 193 may be used to allow an external client 199, outside or within IP Services 198, to receive location information regarding the UEs. All user Internet protocol (IP) packets may be transferred through the UPF 195. The UPF 195 provides UE IP address allocation as well as other functions. The UPF 195 is connected to the IP Services 198. The H-SLP 191 may likewise be connected to the IP Services 198 The IP Services 198 may include the Internet, an intranet, an IP Multimedia Subsystem (IMS), a PS Streaming Service, and/or other IP services.

The base station 102 also may be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The architecture of a gNB 102 may be split into functional parts, e.g., including one or more of a gNB Central Unit (gNB-CU), one or more gNB Distributed Units (gNB-DUs), and one or more gNB Remote Units (gNB-RUs), any of which may be physically co-located or may be physically separate from other parts of the gNB 102. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as an MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). Some of the UEs 104 may be referred to as IIoT devices, such as sensors, instruments, and other devices networked together, in an industrial application, e.g., within a factory. The UE 104 also may be referred to as a station, a mobile station, a subscriber station, a mobile unit, a subscriber unit, a wireless unit, a remote unit, a mobile device, a wireless communication device, a wireless communications device, a remote device, a mobile subscriber station, an access terminal, a mobile terminal, a wireless terminal, a remote terminal, a handset, a user agent, a mobile client, a client, or some other suitable terminology.

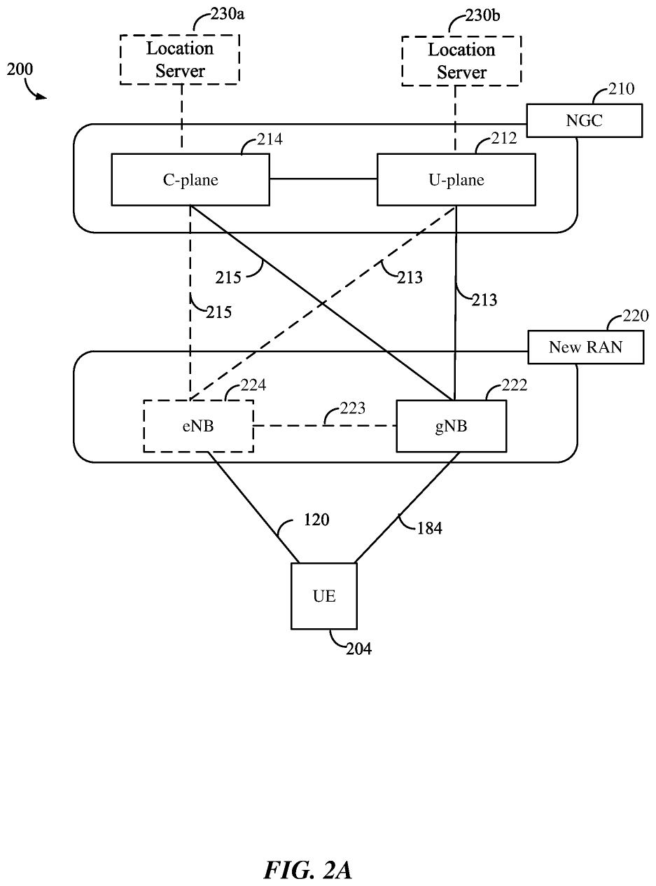

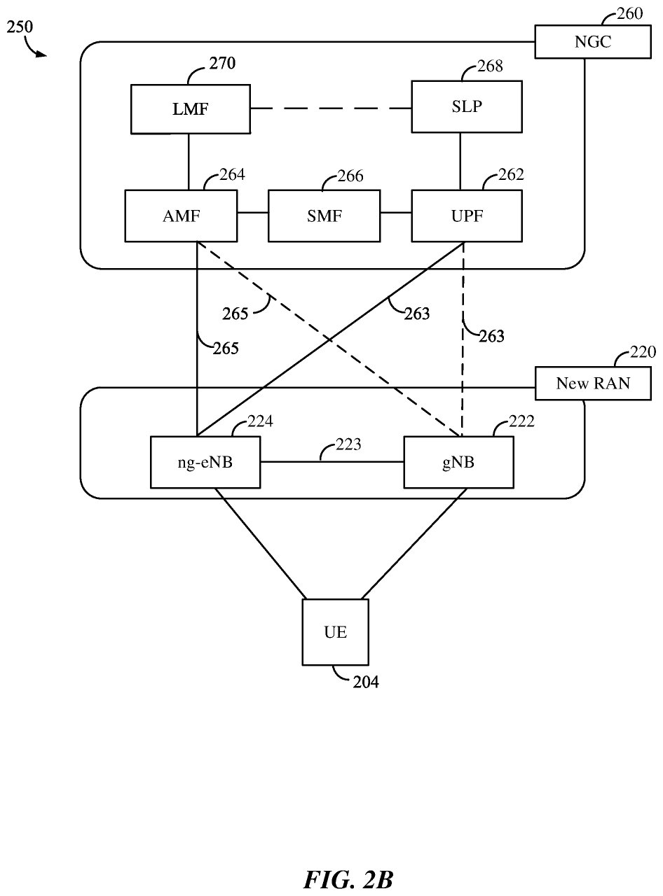

FIG. 2A illustrates an example wireless network structure 200. For example, a next generation core (NGC) 210 (also referred to as a “5GC”) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. In some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1). Another optional aspect may include one or more location servers 230a, 230b (sometimes collectively referred to as location server 230) (which may correspond to LMF 196), which may be in communication with the control plane functions 214 and user plane functions 212, respectively, in the NGC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, NGC 210, and/or via the Internet (not illustrated). Further, the location server 230 may be integrated into a component of the core network, or alternatively may be external to the core network, e.g., in the New RAN 220.

FIG. 2B illustrates another example wireless network structure 250. For example, an NGC 260 (also referred to as a “5GC”) can be viewed functionally as control plane functions, provided by an access and mobility management function (AMF) 264, user plane function (UPF) 262, a session management function (SMF) 266, SUPL Location Platform (SLP) 268, and an LMF 270, which operate cooperatively to form the core network (i.e., NGC 260). User plane interface 263 and control plane interface 265 connect the ng-eNB 224 to the NGC 260 and specifically to UPF 262 and AMF 264, respectively. In an additional configuration, a gNB 222 may also be connected to the NGC 260 via control plane interface 265 to AMF 264 and user plane interface 263 to UPF 262. Further, eNB 224 may directly communicate with gNB 222 via the backhaul connection 223, with or without gNB direct connectivity to the NGC 260. In some configurations, the New RAN 220 may only have one or more gNBs 222, while other configurations include one or more of both ng-eNBs 224 and gNBs 222. Either gNB 222 or ng-eNB 224 may communicate with UEs 204 (e.g., any of the UEs depicted in FIG. 1). The base stations of the New RAN 220 communicate with the AMF 264 264 over the N2 interface and the UPF 262 over the N3 interface.

The functions of the AMF 264 include registration management, connection management, reachability management, mobility management, lawful interception, transport for session management (SM) messages between the UE 204 and the SMF 266, transparent proxy services for routing SM messages, access authentication and access authorization, transport for short message service (SMS) messages between the UE 204 and the short message service function (SMSF) (not shown), and security anchor functionality (SEAF). The AMF also interacts with the authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and the location management function (LMF) 270 (which may correspond to LMF 196), as well as between the New RAN 220 and the LMF 270, evolved packet system (EPS) bearer identifier allocation for interworking with the EPS, and UE 204 mobility event notification. In addition, the AMF 264 also supports functionalities for non-Third Generation Partnership Project (3GPP) access networks.

Functions of the UPF 262 include acting as an anchor point for intra-/inter-RAT mobility (when applicable), acting as an external protocol data unit (PDU) session point of interconnect to the data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., UL/DL rate enforcement, reflective QoS marking in the DL), UL traffic verification (service data flow (SDF) to QoS flow mapping), transport level packet marking in the UL and DL, DL packet buffering and DL data notification triggering, and sending and forwarding of one or more “end markers” to the source RAN node.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the NGC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, NGC 260, and/or via the Internet (not illustrated).

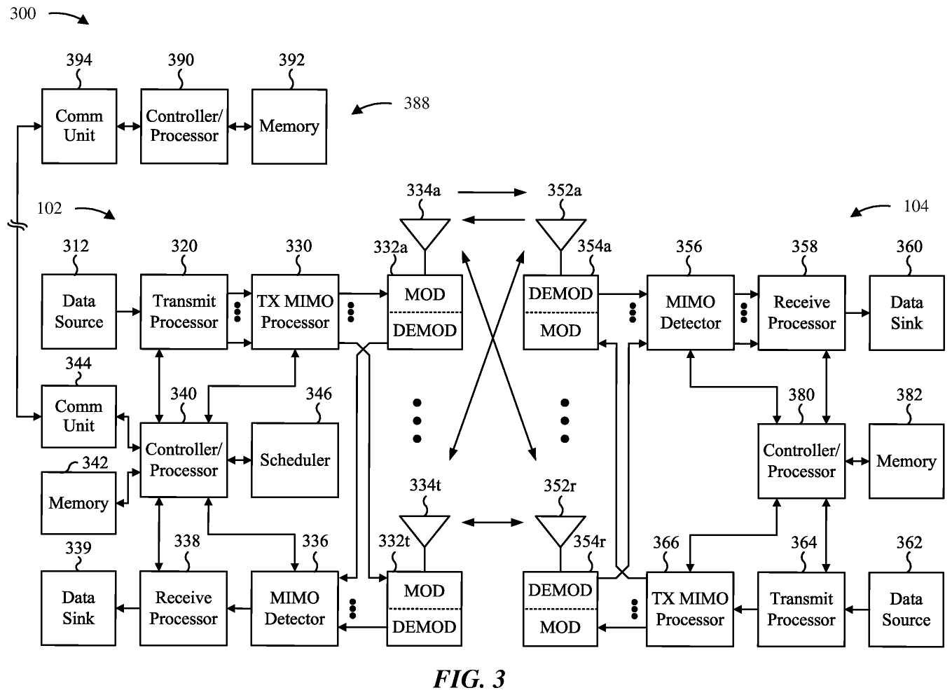

FIG. 3 shows a block diagram of a design 300 of base station 102 and UE 104, which may be one of the base stations and one of the UEs in FIG. 1. Base station 102 may be equipped with T antennas 334a through 334t, and UE 104 may be equipped with R antennas 352a through 352r, where in general T≥1 and R≥1.

At base station 102, a transmit processor 320 may receive data from a data source 312 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 320 may also process system information (e.g., for semi-static resource partitioning information (SRPI) and/or the like) and control information (e.g., CQI requests, grants, upper layer signaling, and/or the like) and provide overhead symbols and control symbols. Transmit processor 320 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 330 may perform spatial processing (e.g., precoding) on the data symbols, the control symbols, the overhead symbols, and/or the reference symbols, if applicable, and may provide T output symbol streams to T modulators (MODs) 332a through 332t. Each modulator 332 may process a respective output symbol stream (e.g., for OFDM and/or the like) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively. According to various aspects described in more detail below, the synchronization signals can be generated with location encoding to convey additional information.

At UE 104, antennas 352a through 352r may receive the downlink signals from base station 102 and/or other base stations and may provide received signals to demodulators (DEMODs) 354a through 354r, respectively. Each demodulator 354 may condition (e.g., filter, amplify, down convert, and digitize) a received signal to obtain input samples. Each demodulator 354 may further process the input samples (e.g., for OFDM and/or the like) to obtain received symbols. A MIMO detector 356 may obtain received symbols from all R demodulators 354a through 354r, perform MIMO detection on the received symbols if applicable, and provide detected symbols. A receive processor 358 may process (e.g., demodulate and decode) the detected symbols, provide decoded data for UE 104 to a data sink 360, and provide decoded control information and system information to a controller/processor 380. A channel processor may determine reference signal received power (RSRP), received signal strength indicator (RSSI), reference signal received quality (RSRQ), channel quality indicator (CQI), and/or the like. In some aspects, one or more components of UE 104 may be included in a housing.

On the uplink, at UE 104, a transmit processor 364 may receive and process data from a data source 362 and control information (e.g., for reports comprising RSRP, RSSI, RSRQ, CQI, and/or the like) from controller/processor 380. Transmit processor 364 may also generate reference symbols for one or more reference signals. The symbols from transmit processor 364 may be precoded by a TX MIMO processor 366 if applicable, further processed by modulators 354a through 354r (e.g., for DFT-s-OFDM, CP-OFDM, and/or the like), and transmitted to base station 102. At base station 102, the uplink signals from UE 104 and other UEs may be received by antennas 334, processed by demodulators 332, detected by a MIMO detector 336 if applicable, and further processed by a receive processor 338 to obtain decoded data and control information sent by UE 104. Receive processor 338 may provide the decoded data to a data sink 339 and the decoded control information to controller/processor 340. Base station 102 may include communication unit 344 and communicate to location server 388 via communication unit 344. Location server 388, which may be, e.g., LMF 196 or E-SMLC 164, in FIG. 1, may include communication unit 394, controller/processor 390, and memory 392.

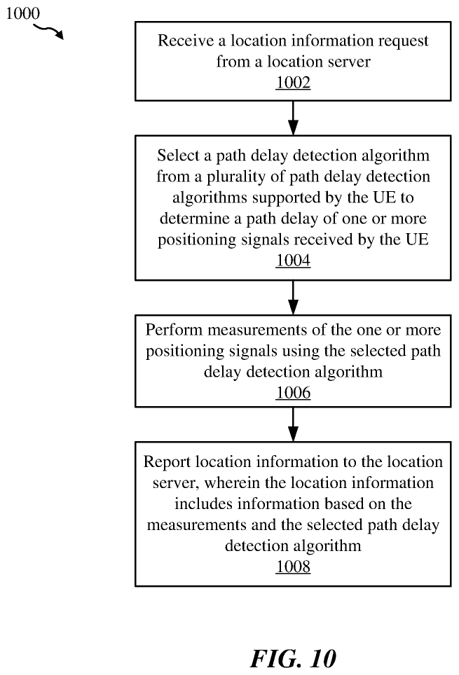

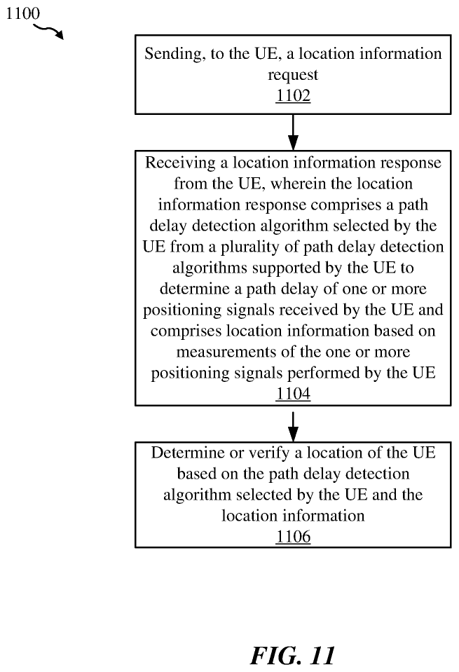

Controller/processor 340 of base station 102, controller/processor 380 of UE 104, and/or any other component(s) of FIG. 3 may perform one or more techniques for performing positioning measurements of a UE, as described in more detail elsewhere herein. For example, controller/processor 380 of UE 104, controller/processor 390 of location server 388, and/or any other component(s) of FIG. 3 may perform or direct operations of, for example, operations 1000 and 1100 of FIGS. 10 and 11, and/or other processes as described herein. Memories 342 and 382 may store data and program codes for base station 102 and UE 104, respectively. In some aspects, memory 342 and/or memory 382 may comprise a non-transitory computer-readable medium storing one or more instructions for wireless communication. For example, the one or more instructions, when executed by one or more processors of the UE 104 and/or the location server 388, may perform or direct operations of, for example, operations 1000 and 1100 of FIGS. 10 and 11 respectively, and/or other processes as described herein. A scheduler 346 may schedule UEs for data transmission on the downlink and/or uplink.

As indicated above, FIG. 3 is provided as an example. Other examples may differ from what is described with regard to FIG. 3.

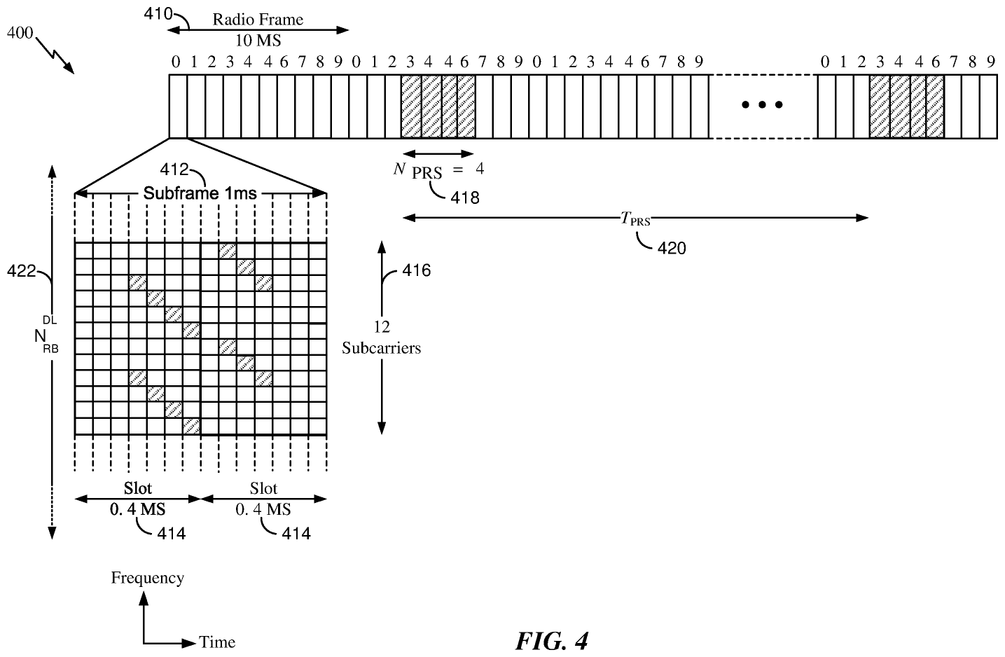

FIG. 4 shows diagram of a structure of an example subframe sequence 400 with positioning reference signal (PRS) positioning occasions, according to aspects of the disclosure. Subframe sequence 400 may be applicable to the broadcast of PRS signals from a base station (e.g., any of the base stations described herein) or another network node. The subframe sequence 400 may be used in LTE systems, and the same or similar subframe sequence may be used in other communication technologies/protocols, such as 5G and NR. In FIG. 4, time is represented horizontally (e.g., on the X axis) with time increasing from left to right, while frequency is represented vertically (e.g., on the Y axis) with frequency increasing (or decreasing) from bottom to top. As shown in FIG. 4, downlink, and uplink radio frames 410 may be of 10 millisecond (ms) duration each. For downlink frequency division duplex (FDD) mode, radio frames 410 are organized, in the illustrated example, into ten subframes 412 of 1 ms duration each. Each subframe 412 comprises two slots 414, each of, for example, 0.5 ms duration.

In the frequency domain, the available bandwidth may be divided into uniformly spaced orthogonal subcarriers 416 (also referred to as “tones” or “bins”). For example, for a normal length cyclic prefix (CP) using, for example, 15 kHz spacing, subcarriers 416 may be grouped into a group of twelve (12) subcarriers. A resource of one OFDM symbol length in the time domain and one subcarrier in the frequency domain (represented as a block of subframe 412) is referred to as a resource element (RE). Each grouping of the 12 subcarriers 416 and the 14 OFDM symbols is termed a resource block (RB) and, in the example above, the number of subcarriers in the resource block may be written as N_{SC}^{RB}=12. For a given channel bandwidth, the number of available resource blocks on each channel 422, which is also called the transmission bandwidth configuration 422, is indicated as N_{RB}^{DL}. For example, for a 3 MHz channel bandwidth in the above example, the number of available resource blocks on each channel 422 is given by N_{RB}^{DL}=15. Note that the frequency component of a resource block (e.g., the 12 subcarriers) is referred to as a physical resource block (PRB).

A base station may transmit radio frames (e.g., radio frames 410), or other physical layer signaling sequences, supporting PRS signals (i.e. a downlink (DL) PRS) according to frame configurations either similar to, or the same as that, shown in FIG. 4, which may be measured and used for a UE (e.g., any of the UEs described herein) position estimation. Other types of wireless nodes (e.g., a distributed antenna system (DAS), remote radio head (RRH), UE, AP, etc.) in a wireless communications network may also be configured to transmit PRS signals configured in a manner similar to (or the same as) that depicted in FIG. 4.

A collection of resource elements that are used for transmission of PRS signals is referred to as a “PRS resource.” The collection of resource elements can span multiple PRBs in the frequency domain and N (e.g., 1 or more) consecutive symbol(s) within a slot 414 in the time domain. For example, the cross-hatched resource elements in the slots 414 may be examples of two PRS resources. A “PRS resource set” is a set of PRS resources used for the transmission of PRS signals, where each PRS resource has a PRS resource identifier (ID). In addition, the PRS resources in a PRS resource set are associated with the same transmission-reception point (TRP). A PRS resource ID in a PRS resource set is associated with a single beam transmitted from a single TRP (where a TRP may transmit one or more beams). Note that this does not have any implications on whether the TRPs and beams from which signals are transmitted are known to the UE.

PRS may be transmitted in special positioning subframes that are grouped into positioning occasions. A PRS occasion is one instance of a periodically repeated time window (e.g., consecutive slot(s)) where PRS are expected to be transmitted. Each periodically repeated time window can include a group of one or more consecutive PRS occasions. Each PRS occasion can comprise a number N_{PRS} of consecutive positioning subframes. The PRS positioning occasions for a cell supported by a base station may occur periodically at intervals, denoted by a number T_{PRS} of milliseconds or subframes. As an example, FIG. 4 illustrates a periodicity of positioning occasions where N_{PRS} equals 4 418 and T_{PRS} is greater than or equal to 20 420. In some aspects, T_{PRS} may be measured in terms of the number of subframes between the start of consecutive positioning occasions. Multiple PRS occasions may be associated with the same PRS resource configuration, in which case, each such occasion is referred to as an “occasion of the PRS resource” or the like.

A PRS may be transmitted with a constant power. A PRS can also be transmitted with zero power (i.e., muted). Muting, which turns off a regularly scheduled PRS transmission, may be useful when PRS signals between different cells overlap by occurring at the same or almost the same time. In this case, the PRS signals from some cells may be muted while PRS signals from other cells are transmitted (e.g., at a constant power). Muting may aid signal acquisition and time of arrival (TOA) and reference signal time difference (RSTD) measurement, by UEs, of PRS signals that are not muted (by avoiding interference from PRS signals that have been muted). Muting may be viewed as the non-transmission of a PRS for a given positioning occasion for a particular cell. Muting patterns (also referred to as muting sequences) may be signaled (e.g., using the LTE positioning protocol (LPP)) to a UE using bit strings. For example, in a bit string signaled to indicate a muting pattern, if a bit at position j is set to ‘0’, then the UE may infer that the PRS is muted for a j^{th} positioning occasion.

A PRS configuration, as described above, including the PRS transmission/muting schedule, is signaled to the UE to enable the UE to perform PRS positioning measurements. The UE is not expected to blindly perform detection of PRS configurations. In some implementations, the PRS may be transmitted in support of a positioning session in which the location of the UE is determined. Thus, one or more positioning occasions may be included within a positioning session.

Note that the terms “positioning reference signal” and “PRS” may sometimes refer to specific reference signals that are used for positioning in LTE systems. However, as used herein, unless otherwise indicated, the terms “positioning reference signal” and “PRS” refer to any type of reference signal that can be used for positioning, such as but not limited to, PRS signals in LTE, navigation reference signals (NRS), transmitter reference signals (TRS), cell-specific reference signals (CRS), channel state information reference signals (CSI-RS), primary synchronization signals (PSS), secondary synchronization signals (SSS), etc.

Similar to DL PRS transmitted by base stations, discussed above, a UE 104 may transmit UL PRS for positioning. The UL PRS may be sometimes referred to as sounding reference signals (SRS) for positioning. Using received DL PRS from base stations and/or UL PRS transmitted to base stations, the UE may perform various positioning methods, such as time of arrival (TOA), reference signal time difference (RSTD), time difference of arrival (TDOA), reference signal received power (RSRP), time difference between reception and transmission of signals (Rx-Tx), Angle of Arrival (AOA) or Angle of Departure (AOD), etc. In some implementations, the DL PRS and UL PRS are received and transmitted jointly to perform Round Trip Time (RTT) positioning measurements with one or multiple base stations (multi-RTT).

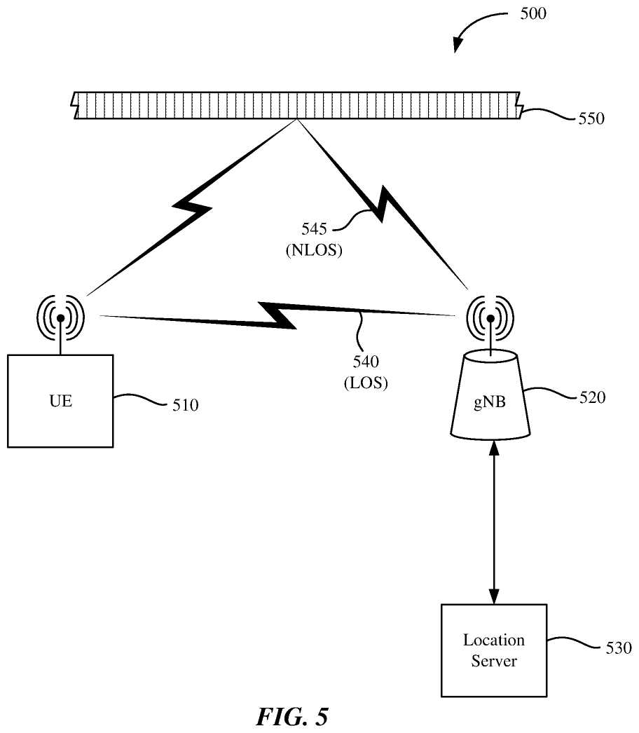

FIG. 5 shows an example wireless network structure 500 which may include a UE 510, a base station 520, and a location server 530. Although only one UE and one base station are shown for simplicity, in other implementations, the wireless network structure 500 may include any feasible number of UEs, base stations, and location servers. The base station 520 may be an example of the base stations 102 of FIG. 1, the UE 510 may be an example of the UEs 104 of FIGS. 1 and 3 and/or the UE 204 of FIGS. 2A and 2B, and the location server 530 may be an example of the LMF 196 or E-SMLC 164 of FIG. 1, location server 230 of FIG. 2A, LMF 270 or SLP 268 of FIG. 2B, location server 388 of FIG. 3. The base station 520 may be configured for 5G (NR) operation and referred to as a gNB. In other implementations, the base station 520 may be any technically feasible base station, such as an ng-eNB or an eNB.

As part of a positioning session to determine the location of UE 510, the location server 530 may transmit one or more messages for positioning to the UE 510 through the base station 520. Additionally, the base station 520 may transmit, and UE 510 may receive, PRS signals 540. The PRS signal 540 may be a line-of-sight signal propagating directly from the base station 520 to the UE 510. Additionally, a non-line-of-sight PRS signal 545 may be received by the UE 510. Non-line-of-sight signals, which are often referred to as multipath signals, are typically signals which are reflected by nearby objects such as a wall 550 or any other feasible object or structure not shown here for simplicity.

The UE 510 may use PRS signals to determine location information that, in turn, are used to determine the location of the UE 510 by the location server 530 or by the UE 510. For example, the UE 510 may extract timing information from a received PRS signal to determine location information. However, if the UE 510 uses a multipath signal, such as the non-line-of-sight PRS signal 545 instead of the line-of-sight PRS signal 540, accuracy of the determined location information may be reduced. For example, additional propagation time associated the non-line-of-sight PRS signal 545 may reduce the associated accuracy of location information. The UE 510 may perform one or more path delay detection algorithms to identify line-of-sight messages and reject non-line-of-sight (multipath) messages. For example, the UE 510 may execute one or more path delay detection algorithms to identify the line-of-sight PRS signal 540 and reject the non-line-of-sight PRS signal 545. The UE 510 may then use the identified line-of-sight PRS signal 540 to determine location information and ignore the non-line-of-sight PRS signal 545. For simplicity, only PRS signals are described with respect to the wireless network structure 500 to determine location information. In other implementations, any other technically feasible signals or messages may be used to determine location information.

In some implementations, the UE 510 may have several path delay detection algorithms available to identify line-of-sight and non-line-of-sight signals. Each path delay detection algorithm may have different requirements, performance guarantees and/or computational complexity. Examples of requirements and performance guarantees may include a length of a required measurement gap, a reporting timeline, accuracy requirements, resources per slot that can be processed, number of hyper parameter combinations, and/or output parameters.

Furthermore, each path delay detection algorithm may have an associated computational complexity. In some implementations, the computation complexity of a path delay detection algorithm may be related to the number of operations, e.g., the number of samples required by an inverse fast Fourier transform (IFFT) needed to perform the associated algorithm. In some aspects, more accurate path delay detection algorithms are more computationally complex than less accurate path delay detection algorithms. Examples path delay detection algorithms and their associated configurable parameters and computational complexities are shown below in Table 1:

TABLE 1

| Algorithm | | Configurable | Computational |
|---|---|---|---|
| Name | Description | Parameters | Complexity |
| Peak | Use oversampled | M, threshold | N - where N is the |
| Detection | IFFT to determine | below max peak, | number of samples |
| | channel freq. | threshold above | in the IFFT |
| | response and | noise floor, | |
| | channel impulse | threshold above | |
| | response to | median | |
| | determine signal | | |
| | peak | | |
| Super | Singular value | Thresholds for | N³ |
| Resolution | decomposition of | path selection | |
| | Hankel matrix or | | |
| | correlation matrix | | |
| Iterative | Estimate path delay | Multiple | N² |
| Least | with largest | thresholds | |
| Square | contribution to the | and stopping | |
| | channel impulse | criteria | |
| | response | | |
| Neural | Reconstruct delays | Neural Network | Based on neural |
| Networks | using autoencoder | Weights | network |
| | | | implementation |

In some implementations, the UE 510 may define one or more classes of path delay detection algorithm that are supported by the UE 510. Each class may be associated with different requirements, performance guarantees, or computational complexities. For example, the UE 510 may determine that a peak detection algorithm is associated with a first class, an iterative least square algorithm is associated with a second class, and a super-resolution algorithm is associated with a third class. A location server, such as location server 530, may request a capabilities report describing the classes of path delay detection algorithms that are supported the UE 510, which the UE 510 may provide to the location server 530.

During a positioning session the UE 510 may select a path delay detection algorithm to process positioning signals received from the location server 530. The path delay detection algorithm may be selected based on a set of requirements, performance guarantees, associated computational complexity, and/or operating conditions of the UE 510. In one operating condition example, the UE 510 may select a path delay detection algorithm based on channel conditions. For example, if the UE 510 is busy with data traffic, then there may be less time available to perform more complex path delay detection algorithms. Thus, if the UE 510 is processing a large amount of UL and DL data traffic (e.g., a volume of transmit and receive data is more than a threshold), then the UE 510 may select a less complex path delay detection algorithm. On the other hand, if the UE 510 is not processing a large amount of UL and DL traffic (e.g., the volume of transmit and receive data is not more than the threshold), then the UE 510 may select a more complex path delay detection algorithm.

In another operating condition example, if a signal-to-noise (SNR) measurement of a signal is greater than a threshold, then the UE 510 may select a less computationally complex path delay detection algorithm. In some cases, detecting multipath propagation may be more difficult with weaker signals. In some implementations, if the UE 510 identifies a relatively strong line-of-sight signal (e.g., a signal having an SNR greater than a threshold), then the UE 510 may use a less computationally complex path delay detection algorithm. On the other hand, if the SNR measurement is not greater than the threshold, then the UE 510 may select a more computationally complex path delay detection algorithm.

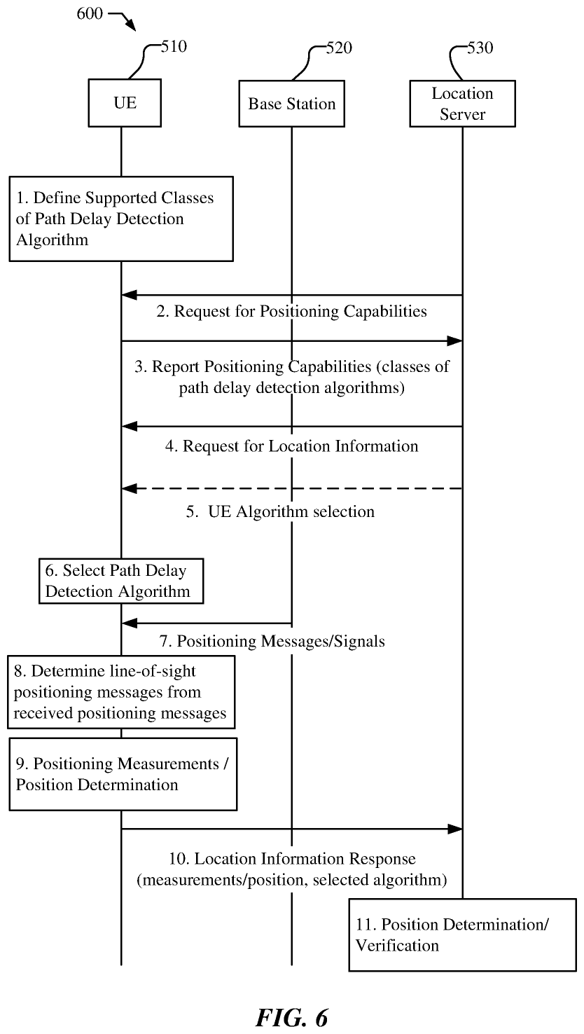

The selected path delay detection algorithm may determine line-of-sight positioning signals from the received positioning signals. The UE 510 may transmit location information determined from the line-of-sight positioning signals to the location server 530. The location server 530 or the UE 510 may use this location information to determine the location of the UE 510. This operation is described in more detail with respect to FIGS. 6-8.

FIG. 6 is a message flow diagram 600 with various messages sent between entities in a wireless system, which may include the UE 510, the base station 520, and the location server 530 of FIG. 5. It should be understood that FIG. 6 is intended to illustrate messaging and actions that are related to path delay detection, as described herein, and that additional messages may be exchanged and actions performed during the positioning session between the various entities shown in FIG. 6, which do not necessarily impact path delay detection as described herein. As described above, non-line-of-sight positioning signals may cause the UE 510 to determine inaccurate location information. In some implementations, the UE 510 may define one or more classes of path delay detection algorithm that are supported by the UE 510. The UE 510 may select one of a plurality of path delay detection algorithms to identify line-of-sight positioning signals and reject non-line-of-sight positioning signals. The UE 510 may determine location information from the identified line-of-sight positioning signals.

At stage 1, the UE 510 defines one or more classes of path delay detection algorithm that are supported by the UE 510, where each of the one or more path delay detection algorithms may identify a line-of-sight positioning signal and reject multipath positioning signals. For example, the one or more path delay detection algorithm may include a peak detection algorithm, a super-resolution algorithm, an iterative least-square algorithm, a neural network based algorithm, or a combination thereof. In some implementations, the classes may be based on a set of requirements, performance guarantees, or computational complexity, and each class may be associated with a different level of computational complexity. For example, the set of requirements of some path delay detection algorithms may include a length of measurement gap (e.g. a gap between two or more messages), a number of resources per slot or millisecond that the UE 510 can process, a reporting timeline, accuracy requirements, resources per slot that can be processed, number of hyper parameter combinations, output parameters or any combination thereof. Performance guarantees may include algorithm processing time, accuracy of identifying and rejecting non-line-of-sight signals or messages, and the like. Computational complexity may include an associated amount of operations that are needed to perform the associated algorithm.

At stage 2, the location server 530 transmits a positioning capabilities request to the UE 510. At stage 3, the UE 510 transmits a positioning capabilities report to the location server 530. In some implementations, the positioning capabilities report may indicate which classes of path delay detection algorithms the UE 510 can support. UEs may have differing capabilities to perform different algorithms. Furthermore, the positioning capabilities an any UE may change over time. For example, some path delay detection algorithms may be more computationally intensive (e.g., use more processor cycles or use more processing time) than others. Therefore, depending on operating conditions of the UE (e.g., associated transmit and receive data traffic, computational load on a processor of the UE, and the like), the positioning capabilities of a UE may change, thereby affecting the available classes of path delay detection algorithm. The location server 530 may determine the positioning capabilities of the UE 510 via stages 2 and 3.

At stage 4, the location server 530 transmits a request for location information to the UE 510.

At stage 5, the location server 530 may transmit a message directing the UE 510 to select a class or use a particular class from the path delay detection algorithms. In some implementations, if an estimated error associated with a previously determined location of UE 510 is greater than a threshold, then the location server 530 may direct the UE 510 use a different class of path delay detection algorithm in an attempt to reduce estimated error. Stage 5 may be optional as depicted with a broken arrow in FIG. 6. Moreover, in some implementations, stage 5 may be combined with stage 4, i.e., the direction to use a particular class of path delay detection algorithm may be included in the request for location information.

At stage 6, the UE 510 selects a path delay detection algorithm. As described with respect to FIG. 5, different path delay detection algorithms may be associated with different requirements, performance guarantees, and/or computational complexities. In some implementations, the UE 510 may select a path delay detection algorithm based on requirements, performance guarantees, and/or computational resources. For example, the path delay detection algorithm may be selected based on channel conditions associated with the UE, which may include a volume of transmit and receive traffic at the UE or may include a signal-to-noise ratio (SNR) measurement of positioning signals received from a base station. In some other implementations, the UE 510 may select a path delay detection algorithm based on a message from the location server as discussed with respect to stage 5.

In one example, the UE 510 may select a path delay detection algorithm based on an associated computational complexity. Execution of any particular path delay detection algorithm may require a predetermined amount of processor resources. Each UE may have different processor speeds, amounts of available memory, or available processor time. Thus, the UE 510 may select a path delay detection algorithm that may be performed with the available processor resources. In some cases, the UE 510 may select the path delay detection algorithm using the largest amount of processor resources that the UE 510 can support. In this manner, the UE 510 may select the most complex path delay detection algorithm based on operating conditions during the positioning session.

In another example, large amounts of transmit and receive data traffic at the UE 510 (e.g., a volume of transmit and receive data is greater than a threshold) may limit the number of positioning messages that may be processed by UE 510. In this case, the UE 510 may select a path delay detection algorithm that may be performed based on the amount of transmit and receive data traffic.

At stage 7, the base station 520 transmits one or more positioning signals to UE 510. In some implementations, the positioning signals may be PRS. In other implementations, the positioning signals may be any technically feasible signal or message that may be used to determine or provide location information. For example, the UE 510 may use timing information associated with the reception of the one or more positioning signals to determine location information. In some implementations, the selection of the path delay detection algorithm in stage 6, may occur after the UE 510 receives the one or more positioning signals.

At stage 8, the UE 510 determines line-of-sight positioning signals from the received positioning signals. For example, the UE 510 may use the selected path delay detection algorithm (selected in stage 6) to identify line-of-sight positioning signals and reject non-line-of-sight positioning signals. In some implementations, the UE 510 may determine location information from the line-of-sight positioning signals.

At stage 9, the UE 510 determines positioning measurements and/or UE position based on the location information from the identified line-of-sight positioning signals. For example, the UE 510 may determine TOA, RSTD, TDOA, RSRP, AOA, AOD or any other technically feasible location information from the identified line-of-sight positioning signals. In some implementations, the UE 510 may perform a position estimation using the determined positioning measurements, e.g., in a UE based positioning procedure. In some implementations, the UE 510 may also determine an error estimate associated with the positioning measurements or position estimate and based on the error estimate, select a different path delay detection algorithm in subsequent position measurements.

At stage 10, the UE 510 may transmit a location information response message to the location server 530. At stage 11, the location server 530 may determine and/or verify the location of the UE 510 based on the location information response messages. In some implementations, the location server 530 may also determine an error estimate associated with the received location information (e.g., the positioning measurements determined by the UE 510). Based on the error estimate, the location server 530 may direct the UE to use a different class of path detection algorithm in subsequent position measurements.

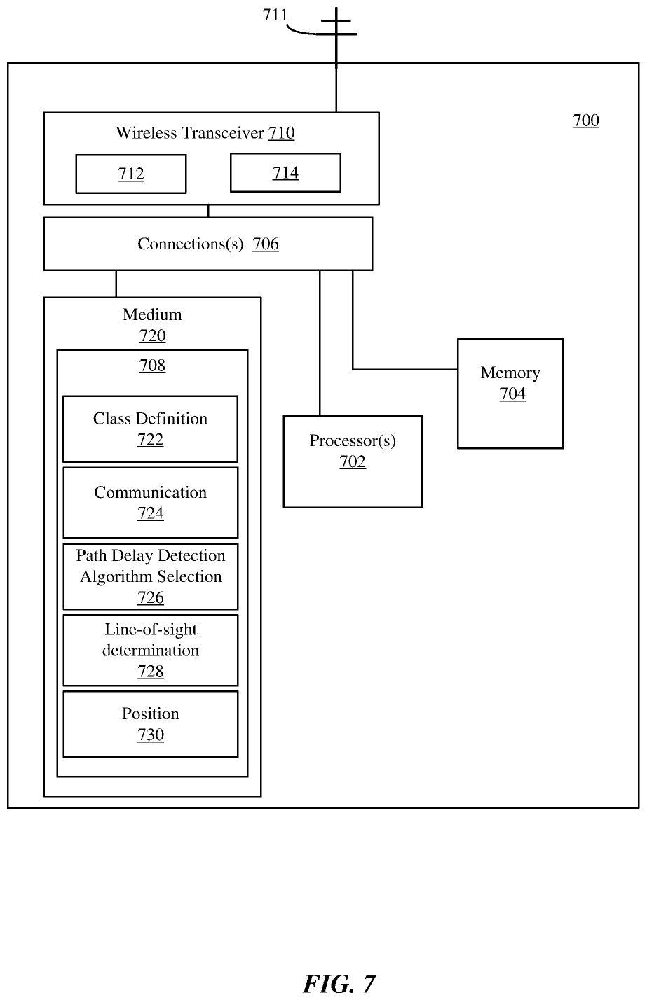

FIG. 7 shows a block diagram illustrating certain exemplary features of a UE 700 that is configured to perform positioning within a wireless network. The UE 700 may be an example of the UEs 104 of FIGS. 1 and 3 and/or the UE 204 of FIGS. 2A and 2B. The UE 700 may, for example, include one or more processors 702, memory 704, an external interface such as a at least one wireless transceiver 710 (e.g., wireless network interface), which may be operatively coupled with one or more connections 706 (e.g., buses, lines, fibers, links, etc.) to a non-transitory computer readable medium 720 and memory 704. The UE 700 may further include additional items, which are not shown, such as a user interface that may include e.g., a display, a keypad or other input device, such as virtual keypad on the display, through which a user may interface with the UE. In certain example implementations, all or part of UE 700 may take the form of a chipset, and/or the like. Wireless transceiver 710 may, for example, include a transmitter 712 enabled to transmit one or more signals over one or more types of wireless communication networks and a receiver 714 to receive one or more signals transmitted over the one or more types of wireless communication networks.

In some implementations, UE 700 may include a UE antenna 711, which may be internal or external. UE antenna 711 may be used to transmit and/or receive signals processed by wireless transceiver 710. In some embodiments, UE antenna 711 may be coupled to wireless transceiver 710. In some implementations, measurements of signals received (transmitted) by UE 700 may be performed at the point of connection of the UE antenna 711 and wireless transceiver 710. For example, the measurement point of reference for received (transmitted) RF signal measurements may be an input (output) terminal of the receiver 714 (transmitter 712) and an output (input) terminal of the UE antenna 711. In a UE 700 with multiple UE antennas 711 or antenna arrays, the antenna connector may be viewed as a virtual point representing the aggregate output (input) of multiple UE antennas. In some embodiments, UE 700 may measure received signals including signal strength and TOA measurements and the raw measurements may be processed by the one or more processors 702.

The one or more processors 702 may be implemented using a combination of hardware, firmware, and software. For example, the one or more processors 702 may be configured to perform the functions discussed herein by implementing one or more instructions or program code 708 on a non-transitory computer readable medium, such as medium 720 and/or memory 704. In some embodiments, the one or more processors 702 may represent one or more circuits configurable to perform at least a portion of a data signal computing procedure or process related to the operation of UE 700.

The medium 720 and/or memory 704 may store instructions or program code 708 that contain executable code or software instructions that when executed by the one or more processors 702, cause the one or more processors 702 to operate as a special purpose computer programmed to perform the techniques disclosed herein. As illustrated in UE 700, the medium 720 and/or memory 704 may include one or more components or modules that may be implemented by the one or more processors 702 to perform the methodologies described herein. While the components or modules are illustrated as software in medium 720 that is executable by the one or more processors 702, it should be understood that the components or modules may be stored in memory 704 or may be dedicated hardware either in the one or more processors 702 or off the processors.

A number of software modules and data tables may reside in the medium 720 and/or memory 704 and be utilized by the one or more processors 702 in order to manage both communications and the functionality described herein. It should be appreciated that the organization of the contents of the medium 720 and/or memory 704 as shown in UE 700 is merely exemplary, and as such the functionality of the modules and/or data structures may be combined, separated, and/or be structured in different ways depending upon the implementation of the UE 700.

The medium 720 and/or memory 704 may include a class definition module 722 that, when implemented by the one or more processors 702, configures the one or more processors 702 to define one or more classes of path delay detection algorithms that may be supported by the UE 700. In some implementations, the classes may be associated with different requirements, performance guarantees, or computational complexities.

The medium 720 and/or memory 704 may include a communication module 724 that, when implemented by the one or more processors 702, configures the one or more processors 702 to transmit and receive messages. For example, execution of the communication module 724 may cause the UE 700 to transmit and receive wireless messages, including positioning messages and positioning signals such as a request for capabilities, a capability report, a location information request and location information report, as well as a message to select a class of path delay detection algorithm, through the wireless transceiver 710.

The medium 720 and/or memory 704 may include a path delay detection algorithm selection module 726 that when implemented by the one or more processors 702 configures the one or more processors 702 to select a path delay detection algorithm from a plurality of path delay detection algorithms available to the UE 700. In some implementations, execution of the path delay detection algorithm may cause the UE 700 to select a path delay detection algorithm based on operating conditions of the UE 700. For example, the path delay detection algorithm selection module 726 may cause the UE 700 to select a path delay detection algorithm based on a volume of transmit and receive data traffic or SNR measurements of positioning signals. In some other implementations, execution of the path delay detection algorithm may cause the UE 700 to select a path delay detection algorithm based on a received message or operating conditions of the UE 700.

The medium 720 and/or memory 704 may include a line-of-sight determination module 728 that, when implemented by the one or more processors 702, configures the one or more processors 702 to determine line of sight messages from received messages. For example, execution of the line-of-sight determination module 728 may cause the UE 700 to use a selected path delay detection algorithm to identify line-of-sight signals and reject non-line-of-sight signals, including positioning signals.

The medium 720 and/or memory 704 may include a position module 730 that, when implemented by the one or more processors 702, configures the one or more processors 702 to perform measurements of positioning signals received via the wireless transceiver 710, e.g., using the selected path delay detection algorithm, and determine a position of the UE 700 based on the line-of-sight messages received by the UE 700. In some implementations execution of the position module 730 may cause the UE 700 to transmit measurement data, position information, and or information regarding the selected data delay detection algorithm to the location server. Execution of the position module 730 may also cause the one or more processors 702 to determine an estimated error associated with measurements and cause the selection of a different path delay detection algorithm in response to the determined error estimate.

The methodologies described herein may be implemented by various means depending upon the application. For example, these methodologies may be implemented in hardware, firmware, software, or any combination thereof. For a hardware implementation, the one or more processors 1002 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 720 or memory 704 that is connected to and executed by the one or more processors 702. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 708 on a non-transitory computer readable medium, such as medium 720 and/or memory 704. Examples include computer readable media encoded with a data structure and computer readable media encoded with a computer program code 708. For example, the non-transitory computer readable medium including program code 708 stored thereon may include program code 708 to support positioning of a UE in a manner consistent with disclosed embodiments. Non-transitory computer readable medium 720 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 708 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 720, instructions and/or data may be provided as signals on transmission media included in a communication apparatus. For example, a communication apparatus may include a wireless transceiver 710 having signals indicative of instructions and data. The instructions and data are configured to cause one or more processors to implement the functions outlined in the claims. That is, the communication apparatus includes transmission media with signals indicative of information to perform disclosed functions.

Memory 704 may represent any data storage mechanism. Memory 704 may include, for example, a primary memory and/or a secondary memory. Primary memory may include, for example, a random access memory, read only memory, etc. While illustrated in this example as being separate from one or more processors 702, it should be understood that all or part of a primary memory may be provided within or otherwise co-located/coupled with the one or more processors 702. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 720. As such, in certain example implementations, the methods and/or apparatuses presented herein may take the form in whole or part of a computer readable medium 720 that may include computer implementable program code 708 stored thereon, which if executed by one or more processors 702 may be operatively enabled to perform all or portions of the example operations as described herein. Computer readable medium 720 may be a part of memory 704.

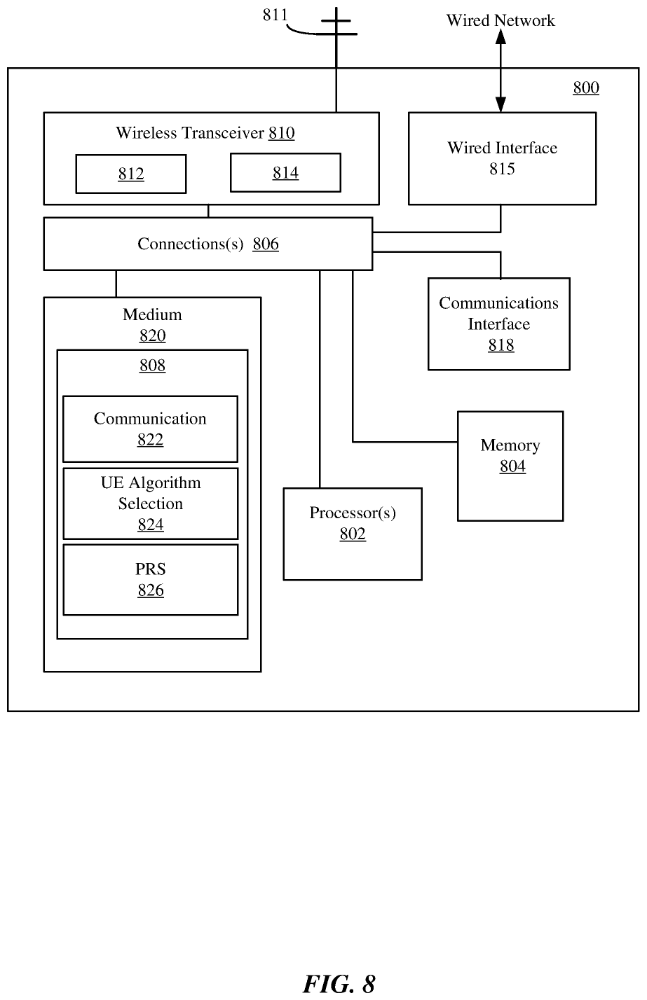

FIG. 8 shows a schematic block diagram illustrating certain exemplary features of a base station 800, e.g., which may be base station 82 shown in FIG. 1, that is configured to perform positioning for a UE within a wireless network, as described herein. The base station 800 may, for example, include one or more processors 802, memory 804, an external interface such as at least one wireless transceiver 810 (e.g., wireless network interface), a wired interface 815, and communications interface 818 (e.g., wireline or wireless network interface to other base stations and/or the core network and a location server), which may be operatively coupled with one or more connections 806 (e.g., buses, lines, fibers, links, etc.) to non-transitory computer readable medium 820 and memory 804. In certain example implementations, all or part of base station 800 may take the form of a chipset, and/or the like. Wireless transceiver 810 may, for example, include a transmitter 812 enabled to transmit one or more signals over one or more types of wireless communication networks and a receiver 814 to receive one or more signals transmitted over the one or more types of wireless communication networks. The wired interface 815 may be operatively coupled with one or more connections 806 to non-transitory computer readable medium 820 and memory 804. In some implementations, the wired interface 815 may provide a wireline (copper, fibre, or any other technically feasible conductor) connection to a network to, for example, provide a backhaul connection to other network entities such as other UEs, a location server, or the like. In some other implementations, a similar wired connection (not shown for simplicity) may be provided by the communications interface 818.

In some embodiments, base station 800 may include antenna 811, which may be internal or external. Base station antenna 811 may be used to transmit and/or receive signals processed by wireless transceiver 810. In some embodiments, base station antenna 811 may be coupled to wireless transceiver 810. In some embodiments, measurements of signals received (transmitted) by base station 1400 may be performed at the point of connection of the antenna 811 and wireless transceiver 810. For example, the measurement point of reference for received (transmitted) RF signal measurements may be an input (output) terminal of the receiver 814 (transmitter 812) and an output (input) terminal of the antenna 811. In a base station 800 with multiple antennas 811 or antenna arrays, the antenna connector may be viewed as a virtual point representing the aggregate output (input) of multiple UE antennas.

The one or more processors 802 may be implemented using a combination of hardware, firmware, and software. For example, the one or more processors 802 may be configured to perform the functions discussed herein by implementing one or more instructions or program code 808 on a non-transitory computer readable medium, such as medium 820 and/or memory 804. In some embodiments, the one or more processors 802 may represent one or more circuits configurable to perform at least a portion of a data signal computing procedure or process related to the operation of base station 800.

The medium 820 and/or memory 804 may store instructions or program code 808 that contain executable code or software instructions that when executed by the one or more processors 802 cause the one or more processors 802 to operate as a special purpose computer programmed to perform the techniques disclosed herein. As illustrated in base station 800, the medium 820 and/or memory 804 may include one or more components or modules that may be implemented by the one or more processors 802 to perform the methodologies described herein. While the components or modules are illustrated as software in medium 820 that is executable by the one or more processors 802, it should be understood that the components or modules may be stored in memory 804 or may be dedicated hardware either in the one or more processors 802 or off the processors.

A number of software modules and data tables may reside in the medium 820 and/or memory 804 and be used by the one or more processors 802 in order to manage both communications and the functionality described herein. It should be appreciated that the organization of the contents of the medium 820 and/or memory 804 as shown in base station 800 is merely exemplary, and as such the functionality of the modules and/or data structures may be combined, separated, and/or be structured in different ways depending upon the implementation of the base station 800.

The medium 820 and/or memory 804 may include a communication module 822 that, when implemented by the one or more processors 802, configures the one or more processors 802 to transmit and receive messages. For example, execution of the communication module 822 may cause the base station 800 to transmit and receive wireless messages through the wireless transceiver 810. In some implementations, execution of the communication module may cause the base station 800 to transmit and/or receive messages to and/or from UEs or other base stations. For example, the base station 800 may relay or “passthrough” one or more messages from one or more UEs to the location server and/or from the location server to one or more UEs.

The medium 820 and/or memory 804 may include a UE algorithm selection module 824 that, when implemented by the one or more processors 802, configures the one or more processors 802 to transmit an algorithm selection message to one or more UEs. The algorithm selection message may indicate a particular class of path delay detection algorithm to select.

The medium 820 and/or memory 804 may include a PRS module 826 that, when implemented by the one or more processors 802, configures the one or more processors 802 to transmit and/or receive PRS signals to/from one or more UEs.

The methodologies described herein may be implemented by various means depending upon the application. For example, these methodologies may be implemented in hardware, firmware, software, or any combination thereof. For a hardware implementation, the one or more processors 802 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 820 or memory 804 that is connected to and executed by the one or more processors 802. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 808 on a non-transitory computer readable medium, such as medium 820 and/or memory 804. Examples include computer readable media encoded with a data structure and computer readable media encoded with a computer program code 808. For example, the non-transitory computer readable medium including program code 808 stored thereon may include program code 808 to support positioning of a UE in a manner consistent with disclosed embodiments. Non-transitory computer readable medium 820 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 808 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 820, instructions and/or data may be provided as signals on transmission media included in a communication apparatus. For example, a communication apparatus may include a wireless transceiver 810 having signals indicative of instructions and data. The instructions and data are configured to cause one or more processors to implement the functions outlined in the claims. That is, the communication apparatus includes transmission media with signals indicative of information to perform disclosed functions.

Memory 804 may represent any data storage mechanism. Memory 804 may include, for example, a primary memory and/or a secondary memory. Primary memory may include, for example, a random access memory, read only memory, etc. While illustrated in this example as being separate from one or more processors 802, it should be understood that all or part of a primary memory may be provided within or otherwise co-located/coupled with the one or more processors 802. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 820. As such, in certain example implementations, the methods and/or apparatuses presented herein may take the form in whole or part of a computer readable medium 820 that may include computer implementable program code 808 stored thereon, which if executed by one or more processors 802 may be operatively enabled to perform all or portions of the example operations as described herein. Computer readable medium 820 may be a part of memory 804.

An entity in a wireless network, such as base station 800, may be configured to perform a means for performing wireless communications with one or more other entities may be, e.g., the wireless transceiver 810 and one or more processors 802 with dedicated hardware or implementing executable code or software instructions in memory 804 and/or medium 820 such as the communication module 822. A means for selecting a path delay detection algorithm may be, e.g., the wireless transceiver 810 and one or more processors 802 with dedicated hardware or implementing executable code or software instructions in memory 804 and/or medium 820 such as the UE algorithm selection module 824. A means for transmitting and/or receiving PRS messages may be, e.g., the wireless transceiver 810 and one or more processors 802 with dedicated hardware or implementing executable code or software instructions in memory 804 and/or medium 820 such as the PRS module 826.

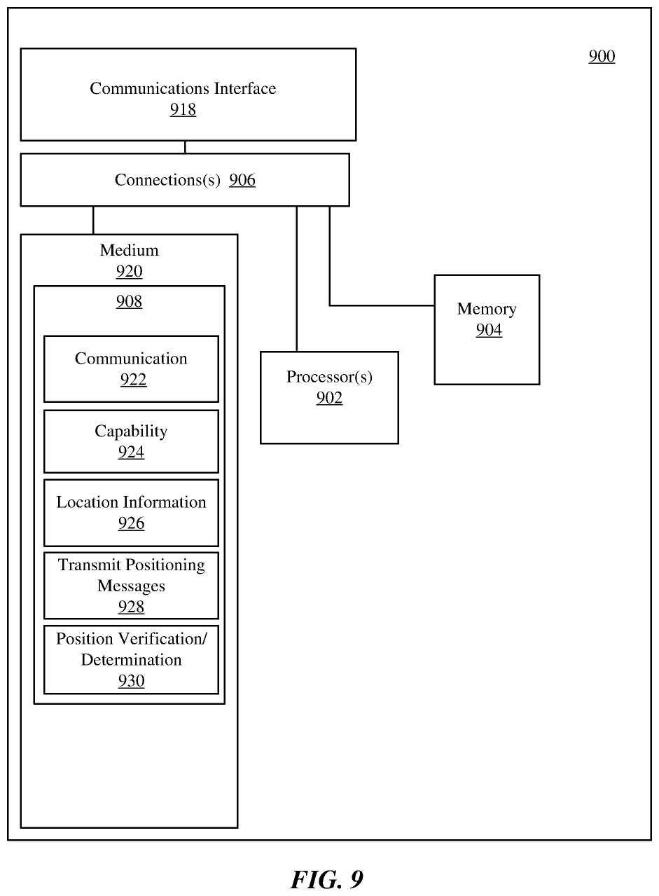

FIG. 9 shows a schematic block diagram illustrating certain exemplary features of a location server 900, e.g., LMF 196 in FIG. 1, that is configured to perform positioning for a UE within a wireless network, as described herein. Location server 900 may, for example, include one or more processors 902, memory 904, an external interface, which may include a communications interface 918 (e.g., wireline or wireless network interface to base stations and/or entities in the core network), which may be operatively coupled with one or more connections 906 (e.g., buses, lines, fibers, links, etc.) to non-transitory computer readable medium 920 and memory 904. In certain example implementations, all or part of location server 900 may take the form of a chipset, and/or the like.

The one or more processors 902 may be implemented using a combination of hardware, firmware, and software. For example, the one or more processors 902 may be configured to perform the functions discussed herein by implementing one or more instructions or program code 908 on a non-transitory computer readable medium, such as medium 920 and/or memory 904. In some embodiments, the one or more processors 902 may represent one or more circuits configurable to perform at least a portion of a data signal computing procedure or process related to the operation of location server 900.

The medium 920 and/or memory 904 may store instructions or program code 908 that contain executable code or software instructions that when executed by the one or more processors 902 cause the one or more processors 902 to operate as a special purpose computer programmed to perform the techniques disclosed herein. As illustrated in location server 900, the medium 920 and/or memory 904 may include one or more components or modules that may be implemented by the one or more processors 902 to perform the methodologies described herein. While the components or modules are illustrated as software in medium 920 that is executable by the one or more processors 902, it should be understood that the components or modules may be stored in memory 904 or may be dedicated hardware either in the one or more processors 902 or off the processors.

A number of software modules and data tables may reside in the medium 920 and/or memory 904 and be utilized by the one or more processors 902 in order to manage both communications and the functionality described herein. It should be appreciated that the organization of the contents of the medium 920 and/or memory 904 as shown in location server 900 is merely exemplary, and as such the functionality of the modules and/or data structures may be combined, separated, and/or be structured in different ways depending upon the implementation of the location server 900.

The medium 920 and/or memory 904 may include a communication module 922 that, when implemented by the one or more processors 902, configures the one or more processors 902 to transmit and receive messages. For example, execution of the communication module 922 may cause the location server 900 to transmit and receive wireless or wireline messages through the communications interface 918. In some implementations, execution of the communication module 922 may cause the base station 900 to transmit and/or receive messages to and/or from UEs or base stations, such as a request for location information, a location information response, request for positioning capabilities, a capability report and a message directing the UE to select a class from the one or more classes of path delay detection algorithms.

The medium 920 and/or memory 904 may include a capability module 924 that, when implemented by the one or more processors 902, configures the one or more processors 902 to transmit, via the communications interface 918, a capability request message to a UE and to receive, via the communications interface 918, a capability report indicating one or more classes of the path delay detection algorithms supported by the UE, wherein each class comprises a set of requirements and performance guarantees. As described herein, a UE may define one or more classes of supported path delay detection algorithms. Execution of the capability module 924 may enable the location server 900 to determine which classes of path delay detection algorithm are supported by the UE.

The medium 920 and/or memory 904 may include a location information module 926 that when implemented by the one or more processors 902 configures the one or more processors 902 to send, via the communications interface 918, a location information request to the UE and to receive, via the communications interface 918, a location information response from the UE. The location information request be transmitted to a UE as part of a positioning session.

The medium 920 and/or memory 904 may include a transmit positioning messages module 928 that when implemented by the one or more processors 902 configures the one or more processors 902 to transmit one or more positioning messages to one or more UEs.

The medium 920 and/or memory 904 may include a position verification/determination module 930 that when implemented by the one or more processors 902 configure the one or more processors 902 to verify or determine the location of a UE. In some implementations, execution of the position verification/determination module 930 may cause the location server 900 to receive location information from the UE that may include measurement and/or position information as well as information regarding the UE selected path delay detection algorithm. Execution of the position verification/determination module 930 may also cause the location server 900 determine an estimated error associated with the determined position or location of the UE. Based on the estimated error, the location server 530 may transmit a message directing the UE to select a different class of path delay detection algorithm.

The methodologies described herein may be implemented by various means depending upon the application. For example, these methodologies may be implemented in hardware, firmware, software, or any combination thereof. For a hardware implementation, the one or more processors 1002 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 920 or memory 904 that is connected to and executed by the one or more processors 902. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 908 on a non-transitory computer readable medium, such as medium 920 and/or memory 904. Examples include computer readable media encoded with a data structure and computer readable media encoded with a computer program code 908. For example, the non-transitory computer readable medium including program code 908 stored thereon may include program code 908 to support positioning of a UE in a manner consistent with disclosed embodiments. Non-transitory computer readable medium 920 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 908 in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media.

In addition to storage on computer readable medium 920, instructions and/or data may be provided as signals on transmission media included in a communication apparatus. For example, a location server 900 may include a communications interface 918 having signals indicative of instructions and data. The instructions and data are configured to cause one or more processors to implement the functions outlined in the claims. That is, the communication apparatus includes transmission media with signals indicative of information to perform disclosed functions.

Memory 904 may represent any data storage mechanism. Memory 904 may include, for example, a primary memory and/or a secondary memory. Primary memory may include, for example, a random access memory, read only memory, etc. While illustrated in this example as being separate from one or more processors 902, it should be understood that all or part of a primary memory may be provided within or otherwise co-located/coupled with the one or more processors 902. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 920. As such, in certain example implementations, the methods and/or apparatuses presented herein may take the form in whole or part of a computer readable medium 920 that may include computer implementable program code 908 stored thereon, which if executed by one or more processors 902 may be operatively enabled to perform all or portions of the example operations as described herein. Computer readable medium 920 may be a part of memory 904.

FIG. 10 shows a flowchart for an example operation 1000 performed by a UR for supporting a positioning session of the UE within a wireless network. The operation 1000 is described below with respect to the UE 510 of FIG. 5 for illustrative purposes only. The operation 1000 also may be performed by the UE 104 of FIGS. 1 and 3, the UE 204 of FIGS. 2A and 2B, or any other feasible UE.

At block 1002, the UE 510 receives a location information request from a location server, e.g., as described at stage 4 of FIG. 6. A means for receiving a location information request from a location server may be, e.g., the wireless transceiver 710 and one or more processors 702 with dedicated hardware or implementing executable code or software instructions in memory 704 and/or medium 720 such as the communication module 724.

At block 1004, the UE 510 selects a path delay detection algorithm from a plurality of path delay detection algorithms supported by the UE to determine a path delay of one or more positioning signals received by the UE, e.g., as described at stage 6 of FIG. 6. In one implementation, the selected path delay detection algorithm may include a peak detection algorithm, a super-resolution algorithm, an iterative least-square algorithm, a neural network based algorithm, or a combination thereof. A means for selecting a path delay detection algorithm from a plurality of path delay detection algorithms supported by the UE to determine a path delay of one or more positioning signals received by the UE may be, e.g., the one or more processors 702 with dedicated hardware or implementing executable code or software instructions in memory 704 and/or medium 720 such as the path delay detection algorithm selection module 726.

At block 1006, the UE 510 performs measurements of the one or more positioning signals using the selected path delay detection algorithm, e.g., as disclosed at stages 8 and 9 of FIG. 6. A means for performing measurements of the one or more positioning signals using the selected path delay detection algorithm may be, e.g., the wireless transceiver 710 and one or more processors 702 with dedicated hardware or implementing executable code or software instructions in memory 704 and/or medium 720 such as the position module 730.

At block 1008, the UE 510 reports location information to the location server, wherein the location information includes the information based on the measurements and the selected path delay detection algorithm, e.g., as disclosed in stage 10 of FIG. 6. A means for reporting location information to the location server, wherein the location information includes information based on the measurements and the selected path delay detection algorithm may be, e.g., the wireless transceiver 710 and one or more processors 702 with dedicated hardware or implementing executable code or software instructions in memory 704 and/or medium 720 such as the communication module 724 and position module 730.

In some implementations, the UE 510 may further determine one or more classes of the plurality of path delay detection algorithms supported by the UE 510, wherein each class comprises a set of requirements, performance guarantees, e.g., as described at stage 1 of FIG. 6. For example, the set of requirements and performance guarantees may include at least one of a length of a required measurement gap, a reporting timeline, accuracy requirements, resources per slot that can be processed, number of hyper parameter combinations, output parameters, or any combination thereof. A means for determining one or more classes of the plurality of path delay detection algorithms supported by the UE, wherein each class comprises a set of requirements and performance guarantees may be, e.g., the one or more processors 702 with dedicated hardware or implementing executable code or software instructions in memory 704 and/or medium 720 such as the class definition module 722. The UE 510 may receive a request for capabilities from the location server, e.g., as described at stage 2 of FIG. 6. In some implementations, the UE 510 may, for example, may receive a capability request from a location server to indicate the one or more classes of path delay detection algorithms supported by the UE 510. A means for receiving a request for capabilities from the location server may be, e.g., the wireless transceiver 710 and one or more processors 702 with dedicated hardware or implementing executable code or software instructions in memory 704 and/or medium 720 such as the communication module 724. The UE 510 may transmit, to the location server, a capability report indicating the one or more classes of the plurality of path delay detection algorithms supported by the UE, e.g., as discussed at stage 3 of FIG. 6. A means for transmitting, to the location server, a capability report indicating the one or more classes of the plurality of path delay detection algorithms supported by the UE may be, e.g., the wireless transceiver 710 and one or more processors 702 with dedicated hardware or implementing executable code or software instructions in memory 704 and/or medium 720 such as the communication module 724.

In one implementation, the selected path delay detection algorithm may be selected based on channel conditions associated with the UE, e.g., as discussed at stage 6 of FIG. 6. For example, the channel conditions may include a volume of transmit and receive traffic at the UE. The channel conditions, for example, may include a signal-to-noise ratio (SNR) measurement of positioning signals received from a base station.

In one implementation, the one or more classes of path delay detection algorithms are associated with a different level of computational complexity, e.g., as discussed at stage 6 of FIG. 6. For example, the path delay detection algorithm may be selected based on the level of computational complexity associated with each class.

In one implementation, the selection of the selected path delay detection algorithm includes receiving a message from the location server directing the UE to select a class of path delay detection algorithm, e.g., as discussed at stage 6 of FIG. 6. A means for receiving a message from the location server directing the UE to select a class of path delay detection algorithm may be, e.g., the wireless transceiver 710 and one or more processors 702 with dedicated hardware or implementing executable code or software instructions in memory 704 and/or medium 720 such as the communication module 724.

In one implementation, the UE 510 may perform measurements of the one or more positioning signals using the selected path delay detection algorithm by determining an error estimate associated with the measurements and selecting a different path delay detection algorithm in response to the determined error estimate, e.g., as discussed in stage 9 of FIG. 6A means for determining an error estimate associated with the measurements and a means for selecting a different path delay detection algorithm in response to the determined error estimate may be, e.g., the one or more processors 702 with dedicated hardware or implementing executable code or software instructions in memory 704 and/or medium 720 such as the position module 730 and path delay detection algorithm selection module 726.

In one implementation, the UE 510 may perform measurements of the one or more positioning signals using the selected path delay detection algorithm by identifying a line-of-sight positioning signal and rejecting multipath positioning signals, e.g., as discussed in stage 8 of FIG. 6. A means for identifying a line-of-sight positioning signal and rejecting multipath positioning signals may be, e.g., the one or more processors 702 with dedicated hardware or implementing executable code or software instructions in memory 704 and/or medium 720 such as the line-of-sight determination module 728.

FIG. 11 shows a flowchart for another example operation 1100 performed by a location server for supporting a positioning session of a UE within a wireless network. The operation 1100 is described below with respect to the location server 530 of FIG. 5 for illustrative purposes only. The operation 1100 also may be performed by LMF 196 or E-SMLC 164 of FIG. 1, location server 230 of FIG. 2A, LMF 270 or SLP 268 of FIG. 2B, location server 388 of FIG. 3, or any other feasible location server.

At block 1102, the location server 530 sends, to the UE, a location information request, e.g., as discussed at stage 4 of FIG. 6. A means for sending, to the UE, a location information request may be, e.g., the communications interface 918 and one or more processors 902 with dedicated hardware or implementing executable code or software instructions in memory 904 and/or medium 920 such as the communication module 922 and location information module 926.

At block 1104, the location server 530 receives a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE, e.g., as discussed at stages 6, 8, 9, and 10 of FIG. 6. A means for receiving a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE may be, e.g., the communications interface 918 and one or more processors 902 with dedicated hardware or implementing executable code or software instructions in memory 904 and/or medium 920 such as the communication module 922 and location information module 926.

At block 1106 the location server 530 determines or verifies a location of the UE based on the path delay detection algorithm selected by the UE and the location information, e.g., as discussed at stage 11 of FIG. 6. A means for determining or verifying a location of the UE based on the path delay detection algorithm selected by the UE and the location information may be, e.g., the one or more processors 902 with dedicated hardware or implementing executable code or software instructions in memory 904 and/or medium 920 such as the position verification/determination module 930.

In one implementation, the location server 530 may further send, to the UE, a request for positioning capabilities, e.g., as discussed at stage 2 of FIG. 6. As described with respect to FIGS. 6 and 7, the UE may determine one or more classes of the path delay algorithms supported by the UE, wherein each class comprises a set of requirements and performance guarantees determine. A means for sending, to the UE, a request for positioning capabilities may be, e.g., the communications interface 918 and one or more processors 902 with dedicated hardware or implementing executable code or software instructions in memory 904 and/or medium 920 such as the communication module 922 and capability module 924. The location server 530 may receive a capability report indicating one or more classes of the plurality of path delay detection algorithms supported by the UE, wherein each class comprises a set of requirements and performance guarantees, e.g., as discussed at stage 3 of FIG. 6. A means for receiving a capability report indicating one or more classes of the plurality of path delay detection algorithms supported by the UE, wherein each class comprises a set of requirements and performance guarantees may be, e.g., the communications interface 918 and one or more processors 902 with dedicated hardware or implementing executable code or software instructions in memory 904 and/or medium 920 such as the communication module 922 and capability module 924.

In one implementation, the set of requirements and performance guarantees may include at least one of a length of a required measurement gap, a reporting timeline, accuracy requirements, resources per slot that can be processed, number of hyper parameter combinations, output parameters, or any combination thereof, as discussed in stage 1 of FIG. 6.

In one implementation, each of the one or more classes of the path delay algorithms is associated with a different level of computational complexity, as discussed in stage 1 of FIG. 6.

In one implementation, the location server may further send, to the UE, a message directing the UE to select a class from the one or more classes of the plurality of path delay detection algorithms, e.g., as discussed at stages 5 and 11 of FIG. 6. A means for sending, to the UE, a message directing the UE to select a class from the one or more classes of the plurality of path delay detection algorithms may be, e.g., the communications interface 918 and one or more processors 902 with dedicated hardware or implementing executable code or software instructions in memory 904 and/or medium 920 such as the position verification/determination module 930.

In one implementation, each of the plurality of path delay detection algorithms identifies a line-of-sight positioning signal and rejects multipath positioning signals, as discussed in stage 1 of FIG. 6.

In one implementation, each of the plurality of path delay detection algorithm includes a peak detection algorithm, a super-resolution algorithm, an iterative least-square algorithm, a neural network based algorithm, or a combination thereof, as discussed in stage 1 of FIG. 6.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures, or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

In view of this description embodiments may include different combinations of features. Implementation examples are described in the following numbered clauses:

Clause 1. A method performed by a user equipment (UE) for supporting a positioning session for the UE comprising: receiving a location information request from a location server; selecting a path delay detection algorithm from a plurality of path delay detection algorithms supported by the UE to determine a path delay of one or more positioning signals received by the UE; performing measurements of the one or more positioning signals using the selected path delay detection algorithm; and reporting location information to the location server, wherein the location information includes information based on the measurements and the selected path delay detection algorithm.

Clause 2. The method of clause 1, further comprising: determining one or more classes of the plurality of path delay detection algorithms supported by the UE, wherein each class comprises a set of requirements and performance guarantees; receiving a request for capabilities from the location server; and transmitting, to the location server, a capability report indicating the one or more classes of the plurality of path delay detection algorithms supported by the UE.

Clause 3. The method of clause 2, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 4. The method of any of clauses 1-3, wherein the selected path delay detection algorithm is selected based on channel conditions associated with the UE.

Clause 5. The method of clause 4, wherein the channel conditions include a volume of transmit and receive traffic at the UE.

Clause 6. The method of any of clauses 4-5, wherein the channel conditions include a signal-to-noise ratio (SNR) measurement of positioning signals received from a base station.

Clause 7. The method of any of clauses 1-6, wherein the one or more classes of the plurality of path delay detection algorithms are associated with different levels of computational complexity.

Clause 8. The method of clause 7, wherein the selected path delay detection algorithm is selected based on the level of computational complexity associated with each class.

Clause 9. The method of any of clauses 1-8, wherein the selecting the selected path delay detection algorithm includes receiving a message from the location server directing the UE to select a class of path delay detection algorithm.

Clause 10. The method of any of clauses 1-9, wherein performing measurements of the one or more positioning signals using the selected path delay detection algorithm comprises: determining an error estimate associated with the measurements; and selecting a different path delay detection algorithm in response to the determined error estimate.

Clause 11. The method of any of clauses 1-10, wherein performing measurements of the one or more positioning signals using the selected path delay detection algorithm comprises identifying a line-of-sight positioning signal and rejecting multipath positioning signals.

Clause 12. The method of any of clauses 1-11, wherein the selected path delay detection algorithm includes a peak detection algorithm, a super-resolution algorithm, an iterative least-square algorithm, a neural network based algorithm, or a combination thereof.

Clause 13. A user equipment (UE) configured for supporting a positioning session, comprising: a wireless transceiver; at least one memory; at least one processor coupled to the wireless transceiver and the at least one memory, the at least one processor configured to: receive, via the wireless transceiver, a location information request from a location server; select a path delay detection algorithm from a plurality of path delay detection algorithms supported by the UE to determine a path delay of one or more positioning signals received by the UE; perform measurements of the one or more positioning signals using the selected path delay detection algorithm; and report, via the wireless transceiver, location information to the location server, wherein the location information includes information based on the measurements and the selected path delay detection algorithm.

Clause 14. The UE of clause 13, wherein the at least one processor is further configured to: determine one or more classes of the plurality of path delay detection algorithms supported by the UE, wherein each class comprises a set of requirements and performance guarantees; receive, via the wireless transceiver, a request for capabilities from the location server; and transmit to the location server, via the wireless transceiver, a capability report indicating the one or more classes of the plurality of path delay detection algorithms supported by the UE.

Clause 15. The UE of clause 14, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 16. The UE of any of clauses 13-15, wherein the selected path delay detection algorithm is selected based on channel conditions associated with the UE.

Clause 17. The UE of clause 16, wherein the channel conditions include a volume of transmit and receive traffic at the UE.

Clause 18. The UE of any of clauses 16-17, wherein the channel conditions include a signal-to-noise ratio (SNR) measurement of positioning signals received from a base station.

Clause 19. The UE of any of clauses 13-18, wherein the one or more classes of the plurality of path delay detection algorithms are associated with different levels of computational complexity.

Clause 20. The UE of clause 19, wherein the selected path delay detection algorithm is selected based on the level of computational complexity associated with each class.

Clause 21. The UE of any of clauses 13-20, wherein the at least one processor is configured to select the selected path delay detection algorithm at least partially based on a message received from the location server directing the UE to select a class of path delay detection algorithm.

Clause 22. The UE of any of clauses 13-21, wherein the at least one processor is configured to perform measurements of the one or more positioning signals using the selected path delay detection algorithm by being configured to: determine an error estimate associated with the measurements; and select a different path delay detection algorithm in response to the determined error estimate.

Clause 23. The UE of any of clauses 13-22, wherein the at least one processor is configured to perform measurements of the one or more positioning signals using the selected path delay detection algorithm by being configured to: identify a line-of-sight positioning signal and reject multipath positioning signals.

Clause 24. The UE of any of clauses 13-23, wherein the selected path delay detection algorithm includes a peak detection algorithm, a super-resolution algorithm, an iterative least-square algorithm, a neural network based algorithm, or a combination thereof.

Clause 25. A user equipment (UE) configured for supporting a positioning session for the UE comprising: means for receiving a location information request from a location server; means for selecting a path delay detection algorithm from a plurality of path delay detection algorithms supported by the UE to determine a path delay of one or more positioning signals received by the UE; means for performing measurements of the one or more positioning signals using the selected path delay detection algorithm; and means for reporting location information to the location server, wherein the location information includes information based on the measurements and the selected path delay detection algorithm.

Clause 26. The UE of clause 25, further comprising: means for determining one or more classes of the plurality of path delay detection algorithms supported by the UE, wherein each class comprises a set of requirements and performance guarantees; means for receiving a request for capabilities from the location server; and means for transmitting, to the location server, a capability report indicating the one or more classes of the plurality of path delay detection algorithms supported by the UE.

Clause 27. The UE of clause 26, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 28. The UE of any of clauses 25-27, wherein the selected path delay detection algorithm is selected based on channel conditions associated with the UE.

Clause 29. The UE of clause 28, wherein the channel conditions include a volume of transmit and receive traffic at the UE.

Clause 30. The UE of any of clauses 28-29, wherein the channel conditions include a signal-to-noise ratio (SNR) measurement of positioning signals received from a base station.

Clause 31. The UE of any of clauses 25-30, wherein the one or more classes of the plurality of path delay detection algorithms are associated with different levels of computational complexity.

Clause 32. The UE of clause 31, wherein the selected path delay detection algorithm is selected based on the level of computational complexity associated with each class.

Clause 33. The UE of any of clauses 25-32, wherein the means for selecting the selected path delay detection algorithm includes means for receiving a message from the location server directing the UE to select a class of path delay detection algorithm.

Clause 34. The UE of any of clauses 25-33, wherein the means for performing measurements of the one or more positioning signals using the selected path delay detection algorithm comprises: means for determining an error estimate associated with the measurements; and means for selecting a different path delay detection algorithm in response to the determined error estimate.

Clause 35. The UE of any of clauses 25-34, wherein the means for performing measurements of the one or more positioning signals using the selected path delay detection algorithm comprises means for identifying a line-of-sight positioning signal and rejecting multipath positioning signals.

Clause 36. The UE of any of clauses 25-35, wherein the selected path delay detection algorithm includes a peak detection algorithm, a super-resolution algorithm, an iterative least-square algorithm, a neural network based algorithm, or a combination thereof.

Clause 37. A non-transitory storage medium including program code stored thereon, the program code is operable to configure at least one processor in a user equipment (UE) for supporting a positioning session, the program code comprising instructions to: receive a location information request from a location server; select a path delay detection algorithm from a plurality of path delay detection algorithms supported by the UE to determine a path delay of one or more positioning signals received by the UE; perform measurements of the one or more positioning signals using the selected path delay detection algorithm; and report location information to the location server, wherein the location information includes information based on the measurements and the selected path delay detection algorithm.

Clause 38. The non-transitory storage medium of clause 37, wherein the program code further comprises instructions to: determine one or more classes of the plurality of path delay detection algorithms supported by the UE, wherein each class comprises a set of requirements and performance guarantees; receive a request for capabilities from the location server; and transmit to the location server a capability report indicating the one or more classes of the plurality of path delay detection algorithms supported by the UE.

Clause 39. The non-transitory storage medium of clause 38, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 40. The non-transitory storage medium of any of clauses 37-39, wherein the selected path delay detection algorithm is selected based on channel conditions associated with the UE.

Clause 41. The non-transitory storage medium of clause 40, wherein the channel conditions include a volume of transmit and receive traffic at the UE.

Clause 42. The non-transitory storage medium of any of clauses 40-41, wherein the channel conditions include a signal-to-noise ratio (SNR) measurement of positioning signals received from a base station.

Clause 43. The non-transitory storage medium of any of clauses 37-42, wherein the one or more classes of the plurality of path delay detection algorithms are associated with different levels of computational complexity.

Clause 44. The non-transitory storage medium of clause 43, wherein the selected path delay detection algorithm is selected based on the level of computational complexity associated with each class.

Clause 45. The non-transitory storage medium of any of clauses 37-44, wherein the program code comprises instructions to select the selected path delay detection algorithm at least partially based on a message received from the location server directing the UE to select a class of path delay detection algorithm.

Clause 46. The non-transitory storage medium of any of clauses 37-45, wherein the program code comprising instructions to perform measurements of the one or more positioning signals using the selected path delay detection algorithm further comprises instructions to: determine an error estimate associated with the measurements; and select a different path delay detection algorithm in response to the determined error estimate.

Clause 47. The non-transitory storage medium of any of clauses 37-46, wherein the program code comprising instructions to perform measurements of the one or more positioning signals using the selected path delay detection algorithm further comprises instructions to: identify a line-of-sight positioning signal and reject multipath positioning signals.

Clause 48. The non-transitory storage medium of any of clauses 37-47, wherein the selected path delay detection algorithm includes a peak detection algorithm, a super-resolution algorithm, an iterative least-square algorithm, a neural network based algorithm, or a combination thereof.

Clause 49. A method performed by a location server for supporting a positioning session for a user equipment (UE) comprising: sending, to the UE, a location information request; receiving a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and determining or verifying a location of the UE based on the path delay detection algorithm selected by the UE and the location information.

Clause 50. The method of clause 49, further comprising: sending, to the UE, a request for positioning capabilities; and receiving a capability report indicating one or more classes of the plurality of path delay detection algorithms supported by the UE, wherein each class comprises a set of requirements and performance guarantees.

Clause 51. The method of clause 50, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 52. The method of any of clauses 50-51, wherein each of the one or more classes of the plurality of path delay algorithms is associated with a different level of computational complexity.

Clause 53. The method of any of clauses 50-52, further comprising sending, to the UE, a message directing the UE to select a class from the one or more classes of the plurality of path delay detection algorithms.

Clause 54. The method of any of clauses 50-53, wherein each of the plurality of path delay detection algorithms identifies a line-of-sight positioning signal and rejects multipath positioning signals.

Clause 55. The method of any of clauses 50-54, wherein each of the plurality of path delay detection algorithms includes a peak detection algorithm, a super-resolution algorithm, an iterative least-square algorithm, a neural network based algorithm, or a combination thereof.

Clause 56. A location server configured for supporting a positioning session for a user equipment (UE) comprising: a communications interface; at least one memory; at least one processor coupled to the communications interface and the at least one memory, the at least one processor configured to: send the UE, via the communications interface, a location information request; receive, via the communications interface, a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and determine or verify a location of the UE based on the path delay detection algorithm selected by the UE and the location information.

Clause 57. The location server of clause 56, wherein the at least one processor is further configured to: send to the UE, via the communications interface, a request for positioning capabilities; and receiving, via the communications interface, a capability report indicating one or more classes of the plurality of path delay detection algorithms supported by the UE, wherein each class comprises a set of requirements and performance guarantees.

Clause 58. The location server of clause 57, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 59. The location server of any of clauses 57-58, wherein each of the one or more classes of the plurality of path delay algorithms is associated with a different level of computational complexity.

Clause 60. The location server of any of clauses 57-59, wherein the at least one processor is further configured to: send to the UE, via the communications interface, a message directing the UE to select a class from the one or more classes of the plurality of path delay detection algorithms.

Clause 61. The location server of any of clauses 57-60, wherein each of the plurality of path delay detection algorithms identifies a line-of-sight positioning signal and rejects multipath positioning signals.

Clause 62. The location server of any of clauses 57-61, wherein each of the o plurality of path delay detection algorithms includes a peak detection algorithm, a super-resolution algorithm, an iterative least-square algorithm, a neural network based algorithm, or a combination thereof.

Clause 63. A location server configured for supporting a positioning session for a user equipment (UE) comprising: means for sending, to the UE, a location information request; means for receiving a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and means for determining or verifying a location of the UE based on the path delay detection algorithm selected by the UE and the location information.

Clause 64. The location server of clause 63, further comprising: means for sending, to the UE, a request for positioning capabilities; and means for receiving a capability report indicating one or more classes of the plurality of path delay detection algorithms supported by the UE, wherein each class comprises a set of requirements and performance guarantees.

Clause 65. The location server of clause 64, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 66. The location server of any of clauses 64-65, wherein each of the one or more classes of the plurality of path delay algorithms is associated with a different level of computational complexity.

Clause 67. The location server of any of clauses 64-66, further comprising means for sending, to the UE, a message directing the UE to select a class from the one or more classes of path delay detection algorithms.

Clause 68. The location server of any of clauses 64-67, wherein each of the plurality of path delay detection algorithms identifies a line-of-sight positioning signal and rejects multipath positioning signals.

Clause 69. The location server of any of clauses 64-68, wherein each of the o plurality of path delay detection algorithms includes a peak detection algorithm, a super-resolution algorithm, an iterative least-square algorithm, a neural network based algorithm, or a combination thereof.

Clause 70. A non-transitory storage medium including program code stored thereon, the program code is operable to configure at least one processor in a location server for supporting a positioning session for a user equipment (UE), the program code comprising instructions to: send to the UE a location information request; receive a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and determine or verify a location of the UE based on the path delay detection algorithm selected by the UE and the location information.

Clause 71. The location server of clause 70, wherein the program code further comprises instructions to: send to the UE a request for positioning capabilities; and receiving a capability report indicating one or more classes of the plurality of path delay detection algorithms supported by the UE, wherein each class comprises a set of requirements and performance guarantees.

Clause 72. The location server of clause 71, wherein the set of requirements and performance guarantees comprises at least one of a length of a required measurement gap, a reporting timeline, accuracy requirements, resources per slot that can be processed, number of hyper parameter combinations, output parameters, or any combination thereof.

Clause 73. The location server of any of clauses 71-72, wherein each of the one or more classes of the plurality of path delay algorithms is associated with a different level of computational complexity.

Clause 74. The location server of any of clauses 71-73, wherein program code further comprises instructions to: send, to the UE, a message directing the UE to select a class from the one or more classes of the plurality of path delay detection algorithms.

Clause 75. The location server of any of clauses 71-74, wherein each of the plurality of path delay detection algorithms identifies a line-of-sight positioning signal and rejects multipath positioning signals.

Clause 76. The location server of any of clauses 71-75, wherein each of the plurality of path delay detection algorithms includes a peak detection algorithm, a super-resolution algorithm, an iterative least-square algorithm, a neural network based algorithm, or a combination thereof.

Therefore, it is intended that claimed subject matter not be limited to the particular examples disclosed, but that such claimed subject matter may also include all aspects falling within the scope of appended claims, and equivalents thereof.

What is claimed is:

1. A method performed by a user equipment (UE) for supporting a positioning session for the UE comprising:
receiving a location information request from a location server;
selecting a path delay detection algorithm from a plurality of path delay detection algorithms supported by the UE to determine a path delay of one or more positioning signals received by the UE;
performing measurements of the one or more positioning signals using the selected path delay detection algorithm; and
reporting location information to the location server, wherein the location information includes information based on the measurements and the selected path delay detection algorithm.

2. The method of claim 1, further comprising:
determining one or more classes of the plurality of path delay detection algorithms supported by the UE, wherein each class comprises a set of requirements and performance guarantees;
receiving a request for capabilities from the location server; and
transmitting, to the location server, a capability report indicating the one or more classes of the plurality of path delay detection algorithms supported by the UE.

3. The method of claim 2, wherein the set of requirements and performance guarantees comprises at least one of a length of a required measurement gap, a reporting timeline, accuracy requirements, resources per slot that can be processed, number of hyper parameter combinations, output parameters, or any combination thereof.

4. The method of claim 1, wherein the selected path delay detection algorithm is selected based on channel conditions associated with the UE.

5. The method of claim 4, wherein the channel conditions include a volume of transmit and receive traffic at the UE, or a signal-to-noise ratio (SNR) measurement of positioning signals received from a base station.

6. The method of claim 1, wherein the selecting the selected path delay detection algorithm includes receiving a message from the location server directing the UE to select a class of path delay detection algorithm.

7. The method of claim 1, wherein performing measurements of the one or more positioning signals using the selected path delay detection algorithm comprises:
determining an error estimate associated with the measurements; and
selecting a different path delay detection algorithm in response to the determined error estimate.

8. The method of claim 1, wherein performing measurements of the one or more positioning signals using the selected path delay detection algorithm comprises identifying a line-of-sight positioning signal and rejecting multipath positioning signals.

9. The method of claim 1, wherein the selected path delay detection algorithm includes a peak detection algorithm, a super-resolution algorithm, an iterative least-square algorithm, a neural network based algorithm, or a combination thereof.

10. A user equipment (UE) configured for supporting a positioning session, comprising:
a wireless transceiver;
at least one memory;
at least one processor coupled to the wireless transceiver and the at least one memory, the at least one processor configured to:
receive, via the wireless transceiver, a location information request from a location server;
select a path delay detection algorithm from a plurality of path delay detection algorithms supported by the UE to determine a path delay of one or more positioning signals received by the UE;
perform measurements of the one or more positioning signals using the selected path delay detection algorithm; and
report, via the wireless transceiver, location information to the location server, wherein the location information includes information based on the measurements and the selected path delay detection algorithm.

11. The UE of claim 10, wherein the at least one processor is further configured to:
determine one or more classes of the plurality of path delay detection algorithms supported by the UE, wherein each class comprises a set of requirements and performance guarantees;
receive, via the wireless transceiver, a request for capabilities from the location server; and
transmit to the location server, via the wireless transceiver, a capability report indicating the one or more classes of the plurality of path delay detection algorithms supported by the UE.

12. The UE of claim 11, wherein the set of requirements and performance guarantees comprises at least one of a length of a required measurement gap, a reporting timeline, accuracy requirements, resources per slot that can be processed, number of hyper parameter combinations, output parameters, or any combination thereof.

13. The UE of claim 10, wherein the selected path delay detection algorithm is selected based on channel conditions associated with the UE.

14. The UE of claim 13, wherein the channel conditions include a volume of transmit and receive traffic at the UE, or a signal-to-noise ratio (SNR) measurement of positioning signals received from a base station.

15. The UE of claim 10, wherein the at least one processor is further configured to select the selected path delay detection algorithm at least partially based on a message received from the location server directing the UE to select a class of path delay detection algorithm.

16. The UE of claim 10, wherein the at least one processor is configured to perform measurements of the one or more positioning signals using the selected path delay detection algorithm by being configured to:
determine an error estimate associated with the measurements; and
select a different path delay detection algorithm in response to the determined error estimate.

17. The UE of claim 10, wherein the at least one processor is configured to perform measurements of the one or more positioning signals using the selected path delay detection algorithm by being configured to:
identify a line-of-sight positioning signal and reject multipath positioning signals.

18. The UE of claim 10, wherein the selected path delay detection algorithm includes a peak detection algorithm, a super-resolution algorithm, an iterative least-square algorithm, a neural network based algorithm, or a combination thereof.

19. A method performed by a location server for supporting a positioning session for a user equipment (UE) comprising:
sending, to the UE, a location information request;
receiving a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and
determining or verifying a location of the UE based on the path delay detection algorithm selected by the UE and the location information.

20. The method of claim 19, further comprising:
sending, to the UE, a request for positioning capabilities; and
receiving a capability report indicating one or more classes of the plurality of path delay detection algorithms supported by the UE, wherein each class comprises a set of requirements and performance guarantees.

21. The method of claim 20, wherein the set of requirements and performance guarantees comprises at least one of a length of a required measurement gap, a reporting timeline, accuracy requirements, resources per slot that can be processed, number of hyper parameter combinations, output parameters, or any combination thereof.

22. The method of claim 20, further comprising sending, to the UE, a message directing the UE to select a class from the one or more classes of the plurality of path delay detection algorithms.

23. The method of claim 20, wherein each of the plurality of path delay detection algorithms identifies a line-of-sight positioning signal and rejects multipath positioning signals.

24. The method of claim 20, wherein each of the plurality of path delay detection algorithms includes a peak detection algorithm, a super-resolution algorithm, an iterative least-square algorithm, a neural network based algorithm, or a combination thereof.

25. A location server configured for supporting a positioning session for a user equipment (UE) comprising:
a communications interface;
at least one memory;
at least one processor coupled to the communications interface and the at least one memory, the at least one processor configured to:
send the UE, via the communications interface, a location information request;
receive, via the communications interface, a location information response from the UE, wherein the location information response comprises a path delay detection algorithm selected by the UE from a plurality of path delay detection algorithms supported by the UE to determine a path delay of one or more positioning signals received by the UE and comprises location information based on measurements of the one or more positioning signals performed by the UE; and
determine or verify a location of the UE based on the path delay detection algorithm selected by the UE and the location information.

26. The location server of claim 25, wherein the at least one processor is further configured to:
send to the UE, via the communications interface, a request for positioning capabilities; and
receiving, via the communications interface, a capability report indicating one or more classes of the plurality of path delay detection algorithms supported by the UE, wherein each class comprises a set of requirements and performance guarantees.

27. The location server of claim 26, wherein the set of requirements and performance guarantees comprises at least one of a length of a required measurement gap, a reporting timeline, accuracy requirements, resources per slot that can be processed, number of hyper parameter combinations, output parameters, or any combination thereof.

28. The location server of claim 26, wherein the at least one processor is further configured to:
send to the UE, via the communications interface, a message directing the UE to select a class from the one or more classes of the plurality of path delay detection algorithms.

29. The location server of claim 26, wherein each of the plurality of path delay detection algorithms identifies a line-of-sight positioning signal and rejects multipath positioning signals.

30. The location server of claim 26, wherein each of the plurality of path delay detection algorithms includes a peak detection algorithm, a super-resolution algorithm, an iterative least-square algorithm, a neural network based algorithm, or a combination thereof.
